(19) United States
(12) Patent Application Publication
(10) Pub. No.: US 2016/0012193 A1
(43) Pub. Date: Jan. 14, 2016

(54) SYSTEM, METHOD AND COMPUTER PROGRAM PRODUCT FOR DISEASE MONITORING AND IDENTIFICATION

(71) Applicant: Gal Almogy, Tel Aviv (IL)

(72) Inventor: Gal Almogy, Tel Aviv (IL)

(73) Assignee: Gal Almogy, Tel Aviv (IL)

(21) Appl. No.: 14/794,848

(22) Filed: Jul. 9, 2015

Related U.S. Application Data
(60) Provisional application No. 62/022,423, filed on Jul. 9, 2014.

(51) Int. Cl. G06F 19/00

(52) U.S. Cl. CPC G06F 19/345

(57) ABSTRACT

A system for diagnosing a patient, the system comprising at least one processor configured to perform the following: obtain at least (a) data defining at least two distinct Local Transmission Zones (LTZs), each LTZ of the LTZs associated with a given diagnosis out of a plurality of potential diagnoses, and (b) patient-related information enabling associating the patient with a given LTZ of the LTZs; and associate the patient with the given LTZ thereby enabling determination of the patient's diagnosis in accordance with the given diagnosis associated with the given LTZ.

### RELATED APPLICATIONS

This application claims priority from U.S. Provisional application Ser. No. 62/022,423 filed on Jul. 9, 2014 which is incorporated by reference herein in its entirety. Reference to documents made in the specification is intended to result in such patents or literature cited are expressly incorporated herein by reference, including any patents or other literature references cited within such documents as if fully set forth in this specification.

### TECHNICAL FIELD

The invention relates to a system, method and computer program product for disease monitoring and identification.

### BACKGROUND

Existing national and global disease monitoring organizations are struggling to implement a disease-containment solution given an infectious agent of pandemic potential. This dearth was hinted at during the SARS pandemic of 2003-04 and during the 2009 Swine-Flu pandemic, spreading rapidly all over the world and infecting in excess of 600 million people within less than a year, despite enormous containment efforts. Fortunately the highly pathogenic SARS pandemic was self-limiting while the Swine-Flu pandemic did not have an unusual pathogenic potential.

While pandemics attract special attention, the problem is not limited to pandemics but is in fact wider and relevant to almost our entire view of communicable (infectious) diseases. The most obvious manifestation of a problem is the diagnosis of potentially infected patients, which is characterized by sub-optimal, averaged, and generic diagnosis, describing a situation rather than specific underlying causes. For example, Influenza-like Illness is a common diagnosis of most respiratory infections, ‘Bronchitis’ is a common diagnosis of cough-related conditions, ‘stomach virus’ is a common diagnosis of stomach illness, etc.

This ‘fuzzy diagnosis’ is considered nowadays sufficient, since even a more thorough set of tests is not likely to reveal the causing agent, and furthermore even if identified there are currently hardly any medication choices for most viral infections.

The result is a cycle in which patients receive the available, sub-optimal limited treatment choice, Doctors of Medicine (MDs) get conditioned/used to providing vague diagnosis, Pharmaceutical companies are denied a vast market of targets and finally, the overall picture is far too complicated for anyone to mount an effective prevention strategy when faced with a pandemic or lower-scale communicable (infectious) diseases.

There is thus a need in the art for a new method and system for disease monitoring and identification.

### GENERAL DESCRIPTION

In accordance with a first aspect of the presently disclosed subject matter there is provided a system for diagnosing a patient, the system comprising at least one processor configured to perform the following: obtain at least (a) data defining at least two distinct Local Transmission Zones (LTZs), each LTZ of the LTZs associated with a given diagnosis out of a plurality of potential diagnoses, and (b) patient-related information enabling associating the patient with a given LTZ of the LTZs; and associate the patient with the given LTZ thereby enabling determination of the patient's diagnosis in accordance with the given diagnosis associated with the given LTZ.

According to some examples, the patient-related information is obtained via a user device and the processor is further configured to provide the patient's diagnosis to the user via the patient device.

According to some examples, the data defining at least two distinct LTZs is obtained from a data repository, directly or indirectly.

According to some examples, the LTZs are non-overlapping.

According to some examples, (1) each LTZ is a sub-area of a given geographical area, (2) the patient-related information includes information of at least one geographical location associated with the patient and (3) the association is performed by determination of the LTZ encompassing the geographical location of the patient.

According to some examples, (1) each LTZ is a group of people out of a certain population (2) the patient-related information includes information of at least one relationship of the patient with another person of the population, and (3) the association is performed by determination of the LTZ encompassing the other person.

According to some examples, the relationship is a spatial relationship being indicative of a distance between the patient and the other person.

According to some examples, the processor is further configured to perform the following for obtaining the data defining at least two distinct Local Transmission Zones (LTZs): obtain LTZ generation data including at least clinical tests results data and spatial information relating to corresponding patients associated with the clinical test results; and generate the LTZs based on the obtained LTZ generation data.

According to some examples, the processor is further configured to perform the following for generating the LTZs:
(a) cluster a given geographical area into two or more candidate LTZs each covering a sub-portion of the given geographical area;
(b) grade the candidate LTZs;
(c) cluster the sub-portions covered by the candidate LTZs for which the grade is below a threshold; and
(d) repeat steps (b) and (c) until all the grades of the candidate LTZs are above the threshold.

According to some examples, the grade is calculated per given causing agent.

According to some examples, the grade is based on at least one of: Signal Separation (SS), Signal Continuity (SC), Spatial Distribution Test (SDT), disease ratio.

According to some examples, the SS is calculated using a signal that is a function of a number of incidences of a causing agent, the sub-portion of the given geographical area covered by the LTZ and a given timeframe.

In accordance with a second aspect of the presently disclosed subject matter there is provided a method for diagnosing a patient, the method comprising: obtaining, by a processor, at least (a) data defining at least two distinct Local Transmission Zones (LTZs), each LTZ of the LTZs associated with a given diagnosis out of a plurality of potential diagnoses, and (b) patient-related information enabling associating the patient with a given LTZ of the LTZs; and associating the patient with the given LTZ thereby enabling determination of the patient's diagnosis in accordance with the given diagnosis associated with the given LTZ.

According to some examples, the patient-related information is obtained via a user device and the method further comprises providing the patient's diagnosis to the user via the patient device.

According to some examples, the data defining at least two distinct LTZs is obtained from a data repository, directly or indirectly.

According to some examples, the LTZs are non-overlapping.

According to some examples, (1) each LTZ is a sub-area of a given geographical area, (2) the patient-related information includes information of at least one geographical location associated with the patient and (3) the associating is performed by determining the LTZ encompassing the geographical location of the patient.

According to some examples, (1) each LTZ is a group of people out of a certain population (2) the patient-related information includes information of at least one relationship of the patient with another person of the population, and (3) the associating is performed by determining the LTZ encompassing the other person.

According to some examples, the relationship is a spatial relationship being indicative of a distance between the patient and the other person.

According to some examples, the obtaining includes: obtaining LTZ generation data including at least clinical tests results data and spatial information relating to corresponding patients associated with the clinical test results; and generating the LTZs based on the obtained LTZ generation data.

According to some examples, the generating includes:
(a) clustering a given geographical area into two or more candidate LTZs each covering a sub-portion of the given geographical area;
(b) grading the candidate LTZs;
(c) clustering the sub-portions covered by the candidate LTZs for which the grade is below a threshold; and
(d) repeating steps (b) and (c) until all the grades of the candidate LTZs are above the threshold.

According to some examples, the grading is calculated per given causing agent.

According to some examples, the grading is based on at least one of: Signal Separation (SS), Signal Continuity (SC), Spatial Distribution Test (SDT), disease ratio.

According to some examples, the SS is calculated using a signal that is a function of a number of incidences of a causing agent, the sub-portion of the given geographical area covered by the LTZ and a given timeframe.

In accordance with a third aspect of the presently disclosed subject matter there is provided a non-transitory computer readable storage medium having computer readable program code embodied therewith, the computer readable program code, executable by at least one processor of a computer to perform a method comprising: obtaining, by a processor, at least (a) data defining at least two distinct Local Transmission Zones (LTZs), each LTZ of the LTZs associated with a given diagnosis out of a plurality of potential diagnoses, and (b) patient-related information enabling associating the patient with a given LTZ of the LTZs; and associating the patient with the given LTZ thereby enabling determination of the patient's diagnosis in accordance with the given diagnosis associated with the given LTZ.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a diagram of an exemplary facility component of a disease monitoring and identification system, in accordance with the presently disclosed subject matter

FIG. 2 is logical block diagram schematically illustrating one example of a system for disease monitoring and identification, in accordance with the presently disclosed subject matter;

FIG. 3 is an illustration showing two examples of LTZs for a given geographical area, in accordance with the presently disclosed subject matter;

FIG. 4 is a flowchart illustrating one example of a sequence of operations carried out for creating data enabling disease monitoring and identification, in accordance with the presently disclosed subject matter;

FIG. 5 is a flowchart illustrating one example of a sequence of operations carried out for generating LTZs, in accordance with the presently disclosed subject matter;

FIG. 6 is a flowchart illustrating one example of a sequence of operations carried out for providing a diagnosis, in accordance with the presently disclosed subject matter;

FIG. 7 is a flowchart illustrating one example of a sequence of operations carried out for creating additional data enabling disease monitoring and identification, in accordance with the presently disclosed subject matter;

FIG. 8 is an illustrative example of signal separation, in accordance with the presently disclosed subject matter;

FIG. 9 is an illustrative example of the signal separation when dividing a given area to different numbers of LTZs, in accordance with the presently disclosed subject matter;

FIG. 10 is an illustrative example of signal continuity, in accordance with the presently disclosed subject matter;

FIGS. 11 and 12 show an exemplary algorithm for deciding whether to perform a clinical test to a patient or not, in accordance with the presently disclosed subject matter;

FIG. 13 shows an example of the medical decision process in accordance with the prior art;

FIG. 14 is a flowchart illustrating one example of a sequence of operations carried out for executing a Context-Aware Systematic Symptom Checker (CASSC) process, in accordance with the presently disclosed subject matter; and

FIG. 15 is a flowchart illustrating one example of utilization of social network data by the system, in accordance with certain examples of the presently disclosed subject matter.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “associating”, “providing”, “determining”, “generating”, “clustering”, “grading”, “repeating” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

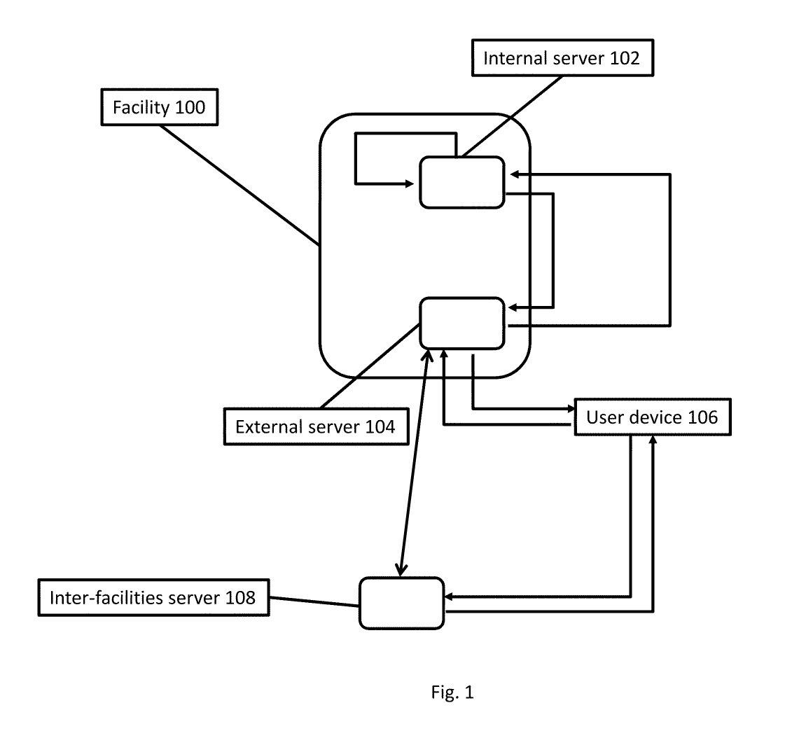

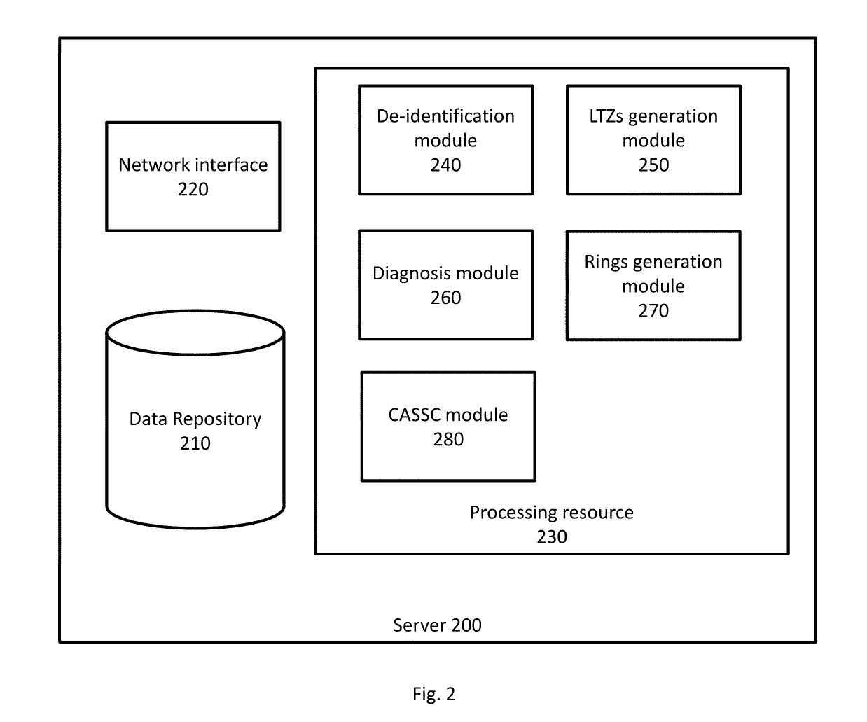

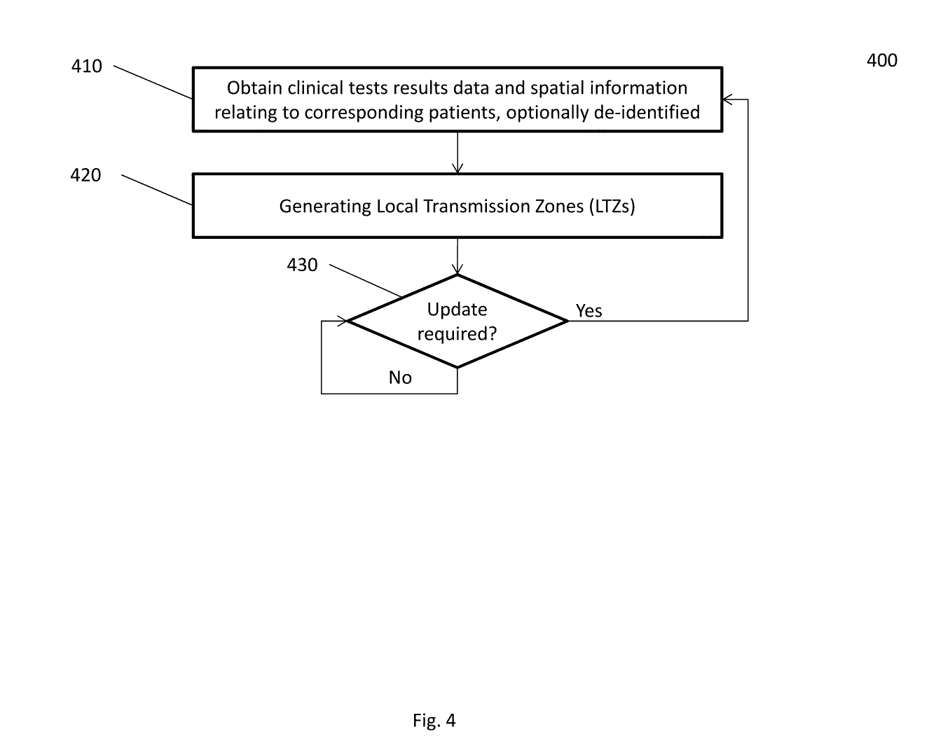

In embodiments of the presently disclosed subject matter, fewer, more and/or different stages than those shown in FIGS. 4-7, 11, 12, 14 and 15 may be executed. In embodiments of the presently disclosed subject matter one or more stages illustrated in FIGS. 4-7, 11, 12, 14 and 15 may be executed in a different order and/or one or more groups of stages may be executed simultaneously. FIGS. 1 and 2 illustrate a general schematic of the system architecture in accordance with an embodiment of the presently disclosed subject matter. Each module in FIGS. 1 and 2 can be made up of any combination of software, hardware and/or firmware that performs the functions as defined and explained herein. The modules in FIGS. 1 and 2 may be centralized in one location or dispersed over more than one location. In other embodiments of the presently disclosed subject matter, the system may comprise fewer, more, and/or different modules than those shown in FIGS. 1 and 2.

Throughout the description use is made of the terms pathogen/s and causing agent/s. It is to be noted that these terms are interchangeable. A disease can be caused by a single pathogen or by a group of pathogens.

In addition, although reference is made to human beings throughout the description, this is not to be limiting and any life form is contemplated, mutatis mutandis. Thus, references to a human being can be replaced by references to animals for example, mutatis mutandis.

Bearing this in mind, attention is drawn to FIG. 1, which schematically illustrates an exemplary facility component of a disease monitoring and identification system (hereinafter: “the System”), in accordance with the presently disclosed subject matter.

In some cases, the facility component of the System can be locally installed on an internal server 102 located at a certain facility 100 (e.g. a hospital, a healthcare center, a health maintenance organization (HMO), or any other facility having access to: (a) clinical test results (e.g., blood tests, bacterial growth tests, viral identification), (b) corresponding timestamps (indicative of the time the test was performed), and optionally also to (c) corresponding spatial information relating to the tested patient (e.g., test X was provided by patient residing in area Y and/or working in area B and/or spatial information about a plurality of locations of the patient within a certain time window that can be collected e.g. using the patients user device 106 periodically and/or continuously, etc.).

Installing the facility component of the System locally, on an internal server 102 located at the facility 100, may in some cases be necessary due to the System's facility component need to access confidential information (e.g. personal information relating to patients including patients treated at the facility 100, etc.) required for its operation, as further detailed herein. Such confidential information can be stored on one or more internal servers 102 located at the facility 100 and accessible by the facility component of the System (that is installed on an internal server 102 that can optionally be one of the confidential servers). In some cases, such internal servers 102 (storing the confidential information) can be inaccessible to external servers 104 external to the facility 100 in which the facility component of the System is installed.

According to the presently disclosed subject matter, in some cases the facility component of the System can further comprise external servers 104. The external servers 104 can comprise non-confidential information, including non-confidential information derived from the confidential information. In some cases the confidential information comprises clinical test results relating to various patients (optionally including identification information enabling identification of the tested patient). In some cases, removing any data that enables associating a certain test result to the tested patient (de-identification of the data) suffices to render the data non-confidential. Therefore, the non-confidential data derived from the confidential data can include such de-identified clinical tests results.

The external servers 104 can be accessible to devices external to the facility 100, e.g. user devices 106 that are external to the facility 100. The user device 106 can include any device that can connect to the external servers 104, e.g. via a wired or wireless connection (e.g. a smart phone, a desktop/laptop computer, a tablet computer, etc. The external servers 104 can be configured to communicate (e.g. send/receive data) with one or more user devices 106 (external to the facility 100), and in some cases only with authorized user devices 106 (e.g. user devices 106 of patients treated at the facility 100). It is to be noted that in some cases the communication between the user devices 106 and the external servers 104 can be indirect (e.g. through an intermediary device, e.g. inter-facilities server 108). In some cases the user devices 106, the inter-facilities server 108 and the external servers 104 can comprise dedicated software for communicating with each other (directly and/or indirectly).

It is to be noted that in some cases all or part of the external servers 104 can reside within the facility 100 as shown in the figure, however in other cases, all or part of the external servers 104 can reside outside the facility as long as they can securely receive the non-confidential information, derived from the confidential information, from the internal servers 102. In addition, in some cases the external servers 104 can be shared by facility components of more than one facility 100.

It is to be further noted that in some cases there may be no need of the external servers 104, for example when the facility component of the System is used only by personnel authorized to access the confidential information, e.g. if the System is installed in a hospital and used by hospital MDs only. In such cases the user devices 106 can be internal to the facility 100 (e.g. computers of MDs of the facility 100, etc.) and can communicate directly with the internal servers 102 (e.g. utilizing dedicated software).

It is to be noted that in some cases, for example when no limitations relating to the privacy/confidentiality of the information exits, there may be no need in separating the internal servers 102 from the external servers 104, and in such cases a single server (or group of servers) can be used as both the internal server and the external server, mutatis mutandis.

According to the presently disclosed subject matter, the external servers 106 can be configured to communicate with inter-facilities server 108. Inter-facilities server 108 can be configured to obtain (physically receive, or receive access to) facility-level information from a plurality of facilities 100 and perform various calculations, including disease monitoring and identification, using the obtained information, as further detailed herein. It is to be noted that the inter-facility server 108 can comprise a group of two or more interconnected servers.

Still further according to the presently disclosed subject matter, the user devices 106 can be configured to receive information relating to a patient (e.g. identification enabling information such as a national identification number and/or symptoms related data) and provide the user with diagnostics of a medical condition of the patient based on the data stored on the internal servers 102 and/or the external servers 104, as further detailed herein.

It is to be noted that when reference is made to servers, it can include any type of computer having data storage and/or data processing capabilities.

Attention is drawn to FIG. 2, showing a logical block diagram schematically illustrating one example of a system for disease monitoring and identification, in accordance with the presently disclosed subject matter.

According to the presently disclosed subject matter, the system can comprise one or more servers 200. The servers 200 can be a combination of one or more internal servers 102 and/or external servers 104 and/or inter-facilities servers 108, or other servers. In some cases, the servers 200 can be distributed between two or more geographical locations. In some cases, all or part of the servers 200 can be operatively connected over one or more computer networks (e.g. utilizing a network interface 220 such as a network card).

All or part of the servers 200 can comprise, or be otherwise associated with, a data repository 210 or parts thereof. Data repository 210 (e.g. a database, a storage system, a memory including Read Only Memory—ROM, Random Access Memory—RAM, or any other type of memory, etc.) can be configured to store data, including inter alia, data relating to: (a) clinical test results (e.g., blood tests, bacterial growth tests, viral identification, etc.), (b) corresponding timestamps (indicative of the time the test was performed), and optionally also to (c) corresponding spatial information relating to the tested patient (e.g., test X was provided by patient residing in area Y and/or working in area B and/or spatial information about a plurality of locations of the patient within a certain time window that can be collected e.g. using the patients user device 106 periodically and/or continuously, etc.).

In some cases, data repository 210 can be further configured to enable retrieval, update and deletion of the stored data. In some cases, data repository 110 can be distributed between two or more geographical locations. In some cases, additionally or alternatively, data repository 210 can be distributed between a plurality of servers 200 (e.g. servers operatively connected over one or more computer networks).

In some cases, multiple data repositories 210 can exist, for example one data repository 210 can comprise information that enables determination of the identities of the patients and another that comprises de-identified information as further detailed herein.

Servers 200 further comprise one or more processing resources 230, that can be processing units, microprocessors, microcontrollers or any other computing devices or modules, including multiple and/or parallel and/or distributed processing units, which are adapted to independently or cooperatively process data for controlling relevant system resources and for enabling operations related to system resources.

The processing resource 230 can comprise one or more of the following modules: de-identification module 240, Local Transmission Zones (LTZs) generation module 250, diagnosis module 260, ring generation module 270, and CASSC module 280.

According to some examples of the presently disclosed subject matter, de-identification module 240 can be configured to obtain data, including data relating to clinical tests of one or more patients, where the data can enable identification of the patients that have been tested, and transform the data in a manner that prevents identification of the tested patients. The transformation can include deleting data that enables identification of the patient (e.g. the patient's name, the patient's national identification number, the patient's address, etc.), or generalizing such data in a manner that will prevent identification of the patient (e.g. reduce the accuracy of the address to a more generalized spatial location data, for example by changing the home address to geographical coordinates (latitude, longitude) and removing a certain number of the last digits (e.g. remove three digits for an accuracy of about 110 square meters). In some cases, data relating to the test results (e.g. determination of a causing agent causing a certain disease), the test's timestamp, the age of the tested patient and other data can be maintained. In some cases, also such data can be generalized (e.g. the timestamp accuracy can be reduced to an hourly/daily/weekly/etc. resolution, the age data accuracy can be reduced to a 1/2/3/4/5-year resolution, etc.). In some cases the data generalization level is determined based on information of specific causing agent/s to be diagnosed. In some cases the de-identification can be performed by grouping information to groups each comprising information obtained from a certain number of patients (e.g. 5 patients, 10 patients, 15 patients, etc.).

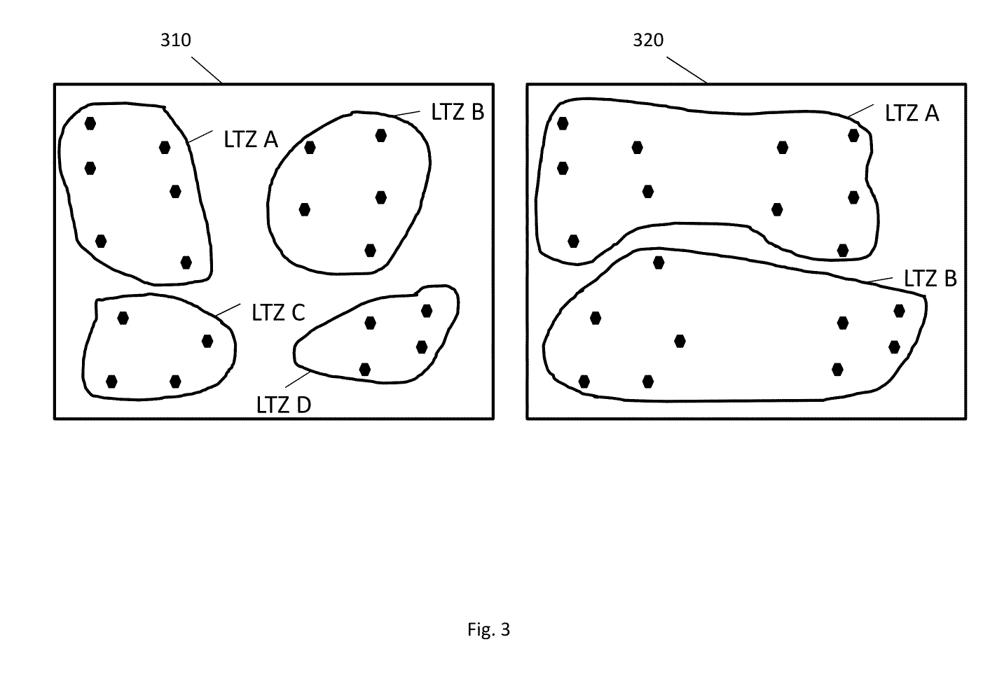

According to some examples of the presently disclosed subject matter, LTZs generation module 250 can be configured to generate LTZs, as further detailed herein, inter alia with respect to FIGS. 3 and 4.

Each LTZ can represent an epidemiologically connected unit, which can be defined as an area in space (e.g. defined using geographical coordinates) or a group of people (e.g. people having a certain spatial relationship with each other at a certain time period) where the likelihood of transmission of a given pathogen within the LTZ is higher than the likelihood of transmission of a pathogen from a first LTZ to a second LTZ. It is to be noted that in some cases the LTZs do not overlap (for the given pathogen of a certain group of LTZs (e.g. a group of LTZs representing a given LTZ resolution, as several resolutions of LTZ can be maintained and in such cases, inter-group overlap is possible)). In some cases the likelihood of transmission of a pathogen from a first LTZ to at least one second LTZ (and in some cases to any other LTZ) is higher by at least a certain percentage (e.g. 10%, 20%, 30%, 40%, 50%, or any other percentage).

It is to be noted that LTZ-to-LTZ disease transfer (e.g. when a person from a first LTZ is infected with a pathogen that until that point was present in a second LTZ and not in the first LTZ) is either assumed to occur at some dynamic rate (a lower rate than internal LTZ transmission rate, and in some cases a much lower rate, lower for example by at least a certain percentage (e.g. 10%, 20%, 30%, 40%, 50%, or any other percentage)) or it can be determined exactly using information of human mobility between LTZs (e.g. having information of a certain person associated with a first LTZ physically enter a second LTZ, for example by entering the geographical boundaries of the second LTZ or by creating a spatial relationship with a person associated with the second LTZ), or it can be extrapolated for example from past observations, or by using other LTZ divisions in which the areas of the first KTZ choice overlap; the degree of overlap in the various LTZ groups may serve as an indicator of LTZ-to-LTZ proximity in the group used (first group).

It is to be noted that the size and/or distribution and/or persistence in time of an LTZ defined as an area in space can be at least geographical area and causing agent specific. Thus, for example, a given geographical area may be divided into K1 (K1 is an integer) LTZs for a first causing agent and K2 (K2 is an integer other than K1) LTZs for a second causing agent and for a given causing agent a first geographical area may be divided into X (X is an integer) LTZs and a second geographical area may be divided into Y (Y is an integer other than X) LTZs.

It is to be further noted that the size and/or distribution and/or persistence in time of an LTZ defined as a group of people can be at least group-of-people and causing agent specific. Thus, for example, a given group of people may be divided into X (X is an integer) LTZs for a first causing agent and Y (Y is an integer other than X) LTZs for a second causing agent and for a given causing agent a first group of people may be divided into M (M is an integer) LTZs and a second group of people may be divided into N (N is an integer other than M) LTZs.

As an example, attention is drawn to FIG. 3, showing two examples of LTZs for a given geographical area, in accordance with the presently disclosed subject matter. At the left hand side of the figure, marked 310, the geographical area has been divided into four LTZs (LTZ A, LTZ B, LTZ C and LTZ D) for a given pathogen, whereas at the right hand side of the figure, marked 320, the same geographical area has been divided into two LTZs (LTZ A and LTZ B) for another pathogen. In this example the LTZs are defined by geography, but, as indicated above, in other cases the LTZs can be defined as a group of people or any other measure of spatial-temporal distance (not shown).

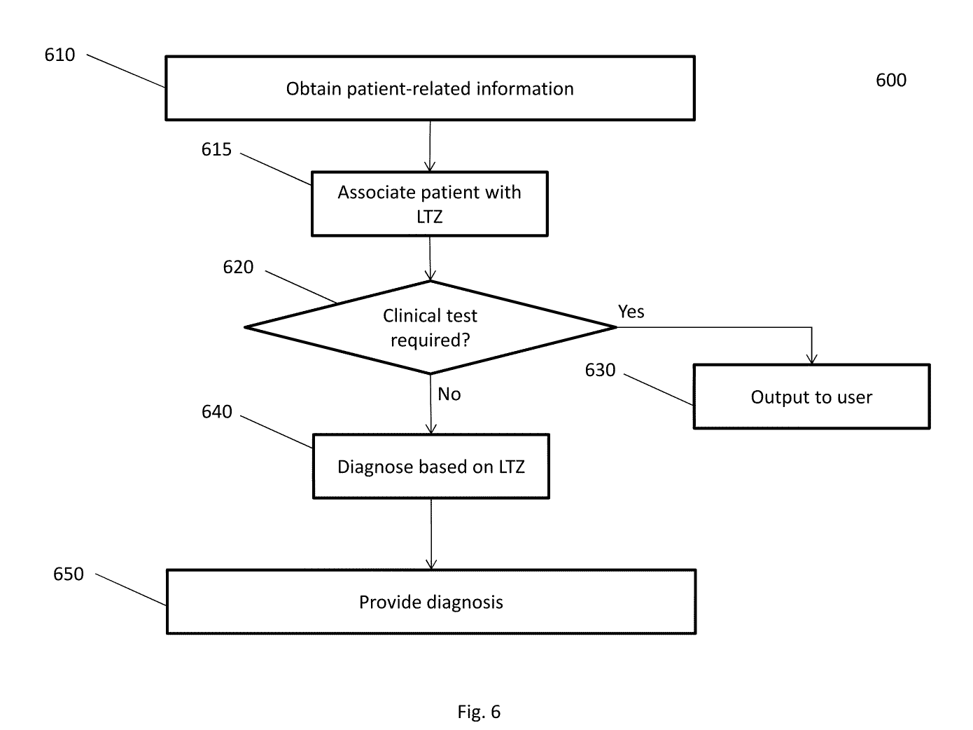

Returning to FIG. 2, according to some examples of the presently disclosed subject matter, diagnosis module 260 can be configured to provide a diagnosis based inter alia on the LTZs, as further detailed herein, inter alia with respect to FIG. 6.

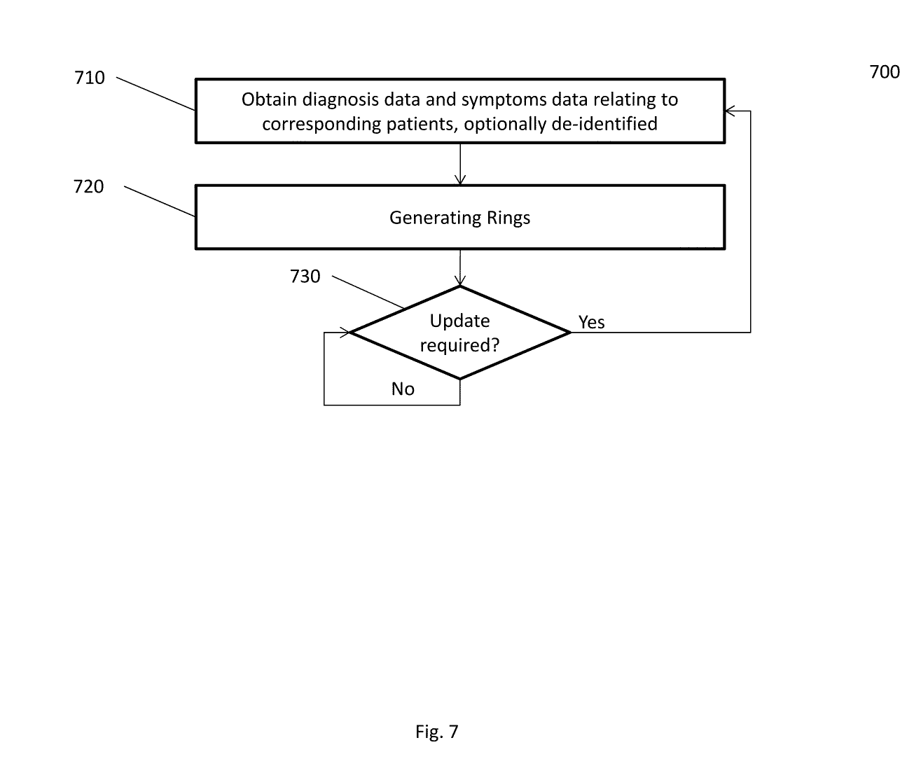

according to some examples of the presently disclosed subject matter, ring generation module 270, can be configured to generate rings, as further detailed herein, inter alia with respect to FIG. 7.

according to some examples of the presently disclosed subject matter, CASSC module 280 can be configured to perform a process of Context-Aware Systematic Symptom Checking as further detailed herein.

Turning to FIG. 4, there is shown a flowchart illustrating one example of a sequence of operations carried out for creating data enabling disease monitoring and identification, in accordance with the presently disclosed subject matter.

According to some examples of the presently disclosed subject matter, system can be configured to perform a diagnosis data creation process 400 (e.g. utilizing LTZs generation module 250). It is to be noted that the diagnosis data creation process 400 can be performed: (1) by internal servers 102 within a certain facility, e.g. for internal use, and/or (2) by external servers 104 within a certain facility or externally thereto, e.g. for external use, e.g. by patients treated within the facility or otherwise associated with the facility (e.g. patients residing within a certain area defined to receive services from a certain facility, etc.), and/or (3) by inter-facility servers 108, e.g. for a population associated with more than one facility (e.g. at least for a first population associated with a first facility and a second population associated with a second facility).

The server 200 that executes the diagnosis data creation process 400 (that can be an internal server 102, and external server 104, or an inter-facility server 108), can be configured to obtain (e.g. by retrieving it from the data repository 210) LTZ generation data including clinical test results data and spatial information data relating to corresponding patients associated with the clinical test results (block 410). The clinical test results data can relate, for example, to blood tests, bacterial growth tests, viral identification, etc., taken from patients. The clinical test results data can include data indicative of the date and time the test was performed (e.g. a timestamp) and data indicative of the identity of the tested patient (e.g. a national identification number). The spatial information relating to the corresponding patients (i.e. the tested patient) can include an indication of the patient's home address and/or work address and/or spatial information about a plurality of locations of the patient within a certain time window that can be collected e.g. using the patient's user device 106 periodically and/or continuously, etc. In some cases additional data can be obtained, including, for example, data of various test results, information of the number of hospitalizations of the patients, information of symptoms reported by the patients, etc.

In some cases, the clinical LTZ generation data can be de-identified data (e.g. when the data is to be used by non internal servers 102, however not thus limited), e.g. de-identified by the de-identification module 240 as detailed herein with respect to FIG. 2 (not shown). It is to be noted that the de-identification of the LTZ generation data can be performed on an internal server 102 (as in some cases it can be the only server having access to the original data that has not been de-identified) and the de-identified data can be sent there from to the data repository 210 associated with the external server 104 and/or to the data repository 210 associated with the inter-facility server 108 (it is to be noted that in some cases these data repositories can be a single data repository accessible by both the external servers 104 and the inter-facilities servers 108).

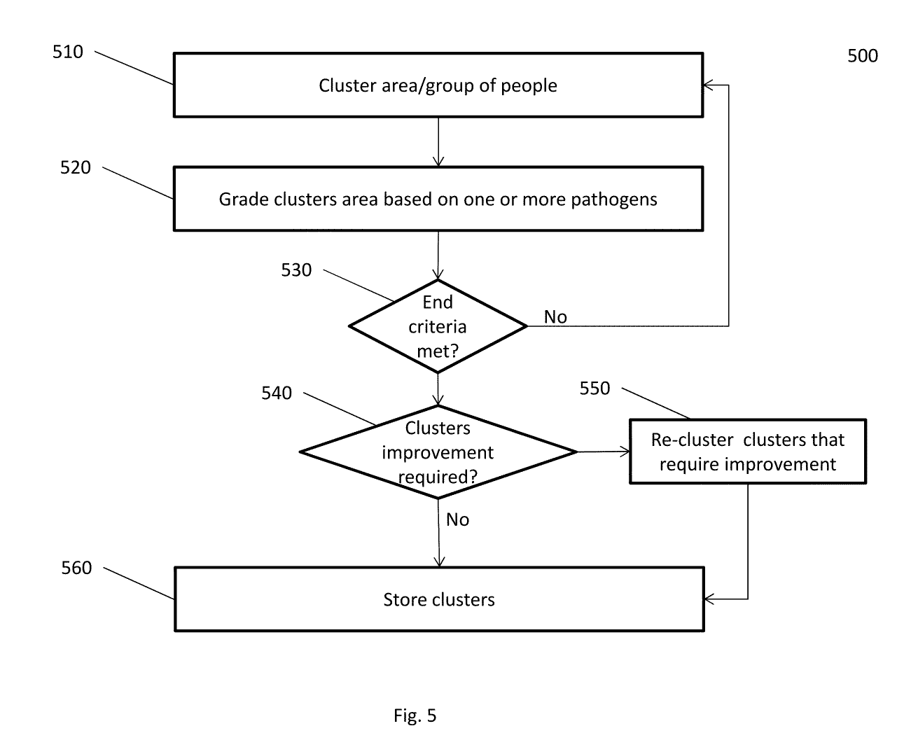

Utilizing the LTZ generation data obtained in block 410, the server 200 that executes the diagnosis data creation process 400 can be configured to generate LTZs (block 420), as further detailed herein, inter alia with respect to FIG. 5. In some cases information relating to the generated LTZs can be stored on data repository 210.

In some cases, the server 200 that executes the diagnosis data creation process 400 can monitor (e.g. continuously, periodically, following a triggering event, etc.) if update of the data enabling disease monitoring and identification is required (block 430) and if so—return to block 410. In some cases, periodical update of the data enabling disease monitoring and identification can be required (the period can be determined inter alia based on the causing agents associated with the LTZs, where for a first causing agent a first update period is maintained and for a second causing agent a second update period is maintained). Additionally or alternatively, update of the data enabling disease monitoring and identification can be required when new clinical test results are obtained due to various reasons. Additionally or alternatively, update of the data enabling disease monitoring and identification can be required when for one or more given LTZs there is not enough data for providing diagnosing one or more patients. Additionally or alternatively, update of the data enabling disease monitoring and identification can be required when an indication is provided by an authorized person (e.g. an MD). Additionally or alternatively, update of the data enabling disease monitoring and identification can be required when the accuracy of the system is below a certain threshold. In some cases the system is updated continuously, so the test in block 430 may be redundant. It is to be noted that these are mere examples of events that can trigger update of the data enabling disease monitoring and identification and other events can trigger the data update.

It is to be noted that, with reference to FIG. 4, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

FIG. 5 shows a flowchart illustrating one example of a sequence of operations carried out for generating LTZs, in accordance with the presently disclosed subject matter.

According to some examples of the presently disclosed subject matter, System can be configured to perform an LTZs generation process 500 (e.g. utilizing LTZs generation module 250). It is to be noted that the LTZs generation process 500 can be performed: (1) by internal servers 102 within a certain facility, e.g. for internal use, and/or (2) by external servers 104 within a certain facility or externally thereto, e.g. for external use, e.g. by patients treated within the facility or otherwise associated with the facility (e.g. patients residing within a certain area defined to receive services from a certain facility, etc.), and/or (3) by inter-facility servers 108, e.g. for a population associated with more than one facility (e.g. at least for a first population associated with a first facility and a second population associated with a second facility).

According to some examples of the presently disclosed subject matter, the server 200 that executes the LTZs generation process 500 can be configured to cluster (e.g. using k-means clustering, or any other suitable clustering algorithm known in the art) a given area (defined for example by geographical coordinates, etc.) into two or more candidate Local Transmission Zones (LTZs) (block 510).

It is to be noted that in some cases, authorized personnel (e.g. MDs), can decide to remove certain parts of the given area so that such parts will be ignored during the LTZ generation process 500.

In some cases, distance is calculated between each pair of tested patients (and in some cases also non-tested patients), and the clustering is performed in accordance with the calculated distances. In some cases the calculated distances are based on static locations (e.g. home address, work address, etc.). Additionally and/or alternatively, the calculated distances are based on dynamic location information, obtained for example by any type of positioning system (e.g. GPS, WiFi association information, etc.). In such cases, the distance calculation can include summing the distances between each pair of tested patients (and in some cases also non-tested patients) and dividing it by the sum of the time period the pair of patients were within a certain distance from one another. In some cases weights can be assigned to the distances (so that, for example, in case patient A was at a distance X1 from patient B the sum of the time divided by the distance X1 can be multiplied by a first factor, whereas in case patient A was at a distance X2, smaller than X1, the sum of the time divided by the distance X1 can be multiplied by a second factor, larger than the first factor.

In some cases, outliers are removed, e.g. prior to the clustering. For example, in case the distances between a certain patient and the remaining patients are above a certain threshold, such patients can be removed from the clustering process, automatically or manually (e.g. by an authorized person such as an MD).

The resulting clusters can be a geographical sub-area, or a sub-groups of people within the given area. In some cases, each cluster is required to comprise or encompass at least a certain number of patients (e.g. at least 10 patients) and in some cases, at least a certain number of patients infected with one or more pathogens according to the clinical tests results data.

In some cases the number of clusters is pre-determined and the system attempts to divide the given area into that pre-determined number of clusters, however in other cases, the system can be configured to calculate the number of clusters, e.g. using an iterative process in which the given area is clustered into a different number of clusters each time. In additional and/or alternative cases, the given area can be clustered into two or more groups of clusters, where at least two groups are comprised of a different number of clusters (e.g. one group comprising ten clusters, another group comprising twenty clusters, etc.).

The resulting clusters can optionally be graded (block 520), e.g. utilizing the clinical test results data and spatial information data relating to corresponding patients obtained in block 410. In some cases, only part of the data obtained in block 410 is utilized, and in some cases the determination of which part of the data to use depends on the one or more given pathogens. For example, when the given pathogen is X (e.g. Flu), only those parts of the data obtained in block 410 that relate to clinical tests performed within a timeframe of Y days (e.g. 10 days) will be utilized. It is to be noted that the system requires a minimal amount of clinical tests data and spatial information data relating to corresponding patients obtained in block 410 in order to initialize. In the absence of sufficient data therefore the system can wait until a sufficient amount is collected (in some cases, the system can be configured to output to the user to perform a clinical test). In some cases, there is also a requirement for a minimal number of clinical tests that yielded positive results during a certain time period before the clustering is performed.

The grades can be calculated for example based on one or more of: Signal Separation (SS), Signal Continuity (SC), Spatial distribution test (SDT), or any other grading enabling calculation that considers the clinical test results data and spatial information data relating to corresponding patients obtained in block 410, and whose results can assist in determining the quality of the LTZs.

For Signal Separation (SS), each disease is treated as a signal in time and space with magnitude determined by the incidence distribution of the causing agent. The Disease Signal (DS) can be a function of a causing agent (V), an LTZ area in space (A) and a timeframe (T)−DS=F(V,A,T). One exemplary disease signal function is a count the number of incidences of the causing agent (V) at the LTZ area in space (A) during the timeframe (T). It is to be noted that DS can be other functions (e.g. sum, frequency, max, etc.) of V (the number of incidences of the causing agent), A (the LTZ area in space) and T (the timeframe).

In some cases, more recent clinical test results are given higher weight in comparison to less recent clinical test results (e.g. one-day old clinical test results count twice as much as four-days old clinical test results, etc.).

For example, for a first LTZ having a first number of incidences of a given causing agent, a first area in space and a first timeframe, the signal will be a first signal and for a second LTZ having a second number of incidences of the given causing agent, a second area in space and a second timeframe, the signal will be a second signal. it can be appreciated thus, that in some cases a first LTZ, having a given number of incidences of the causing agent during a given timeframe, where the incidences are distributed over a first area, may have a different signal than a second LTZ having the same given number of incidences of the causing agent during the same given timeframe, where the incidences are distributed over a second area, smaller or larger than the first area (which can naturally affect the population density). In a more general sense, any change in any of the parameters results in a change to the signal.

It can be appreciated in this regard that since communicable diseases pass inter alia via physical proximity, people that live in nearby homes are statistically more likely to have similar diseases than are far removed people. Therefore, people that come from the same household (an extreme example) separated by 4 days and displaying similar symptoms probably suffer from the same disease causing-agent. If the two individuals were separated by 2 months and/or significant distance (e.g. living in different towns) then it would be less probable that both are associated with the same LTZ (i.e. may have the same disease causing agent). It is to be noted that this approach is very clear and intuitive on the conceptual level with two very near/far events and a single causing agent considered, however it becomes practically AND conceptually far more complicated when applied to real life events/data and data that includes noise (e/g/erroneous clinical test results) and/or incomplete data (e.g. (1) ‘incomplete interaction data’, i.e. the exact distance between two individuals (which is a function of physical distance, activity-type (e.g. Sexually Transmitted Diseases infections) and time spent at each distance, are not exactly known; (2) Incomplete causing-agent data: just because we know a person is sick doesn't mean we know with what, even if clinically tested for X Y and Z; (3) On the most basic level, the factors that make one person get infected while another stays healthy are not known, even when/if the distance between them is 100% known, etc.).

Signal Separation is common in signal processing and is basically the process of removing ‘noise’ and separating the individual vector components (signal de-convolution). An LTZ with well separated signals means that at most given times the LTZ is homogeneous, i.e. all ‘events’ within LTZ may be tracked back to a single causing agent out of a group of potential causing agents (e.g. causing agents that can cause the same disease presentation as the actual single causing agent). In some cases, well separated signals can allow the System to determine/diagnose the diseases of patients with minimal requirement for performing clinical tests to the patients for which diagnosis is sought.

It is to be noted that when the signal separation is high, it can be useful in validating clinical test results, as in case a test result indicates a certain causing agent that is different than the dominant causing agent, this may indicate an error in the clinical test.

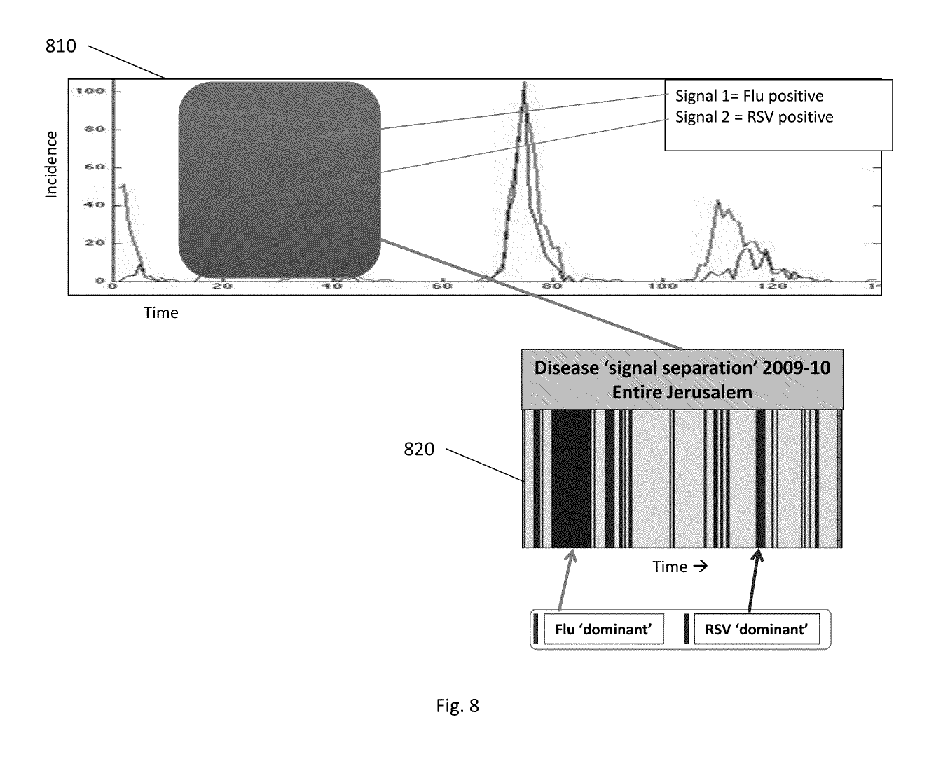

An example for signal separation is provided in FIG. 8. Graph 810 shows two disease signals, Signal 1 represents patients infected with Flu and Signal 2 represents patients infected with Respiratory Syncytial Virus (RSV), in a given LTZ. Image 820 shows the signal separation at a certain time frame marked by a rectangle in graph 810. It can be appreciated that at the beginning of the marked time frame there is a variable amount of Flu incidences, whereas no RSV incidence exists. Therefore, there is a high separation and Flu is very dominant. This is indicated by the thick line shown at image 820 and marked ‘Flu dominant’. After a certain time, we can see that the number of Flu incidences dramatically decreases and the number of RSV incidences dramatically increases. After the signals intersect at the time frame marked by the rectangle in graph 810, the RSV becomes dominant, for a shorter time frame than the Flu was dominant. This is indicated by the line marked ‘RSV dominant’ at image 820, which is thinner than the line marked ‘Flu dominant’ as the time frame in which the RSV was dominant is shorter than the time frame the Flu was dominant.

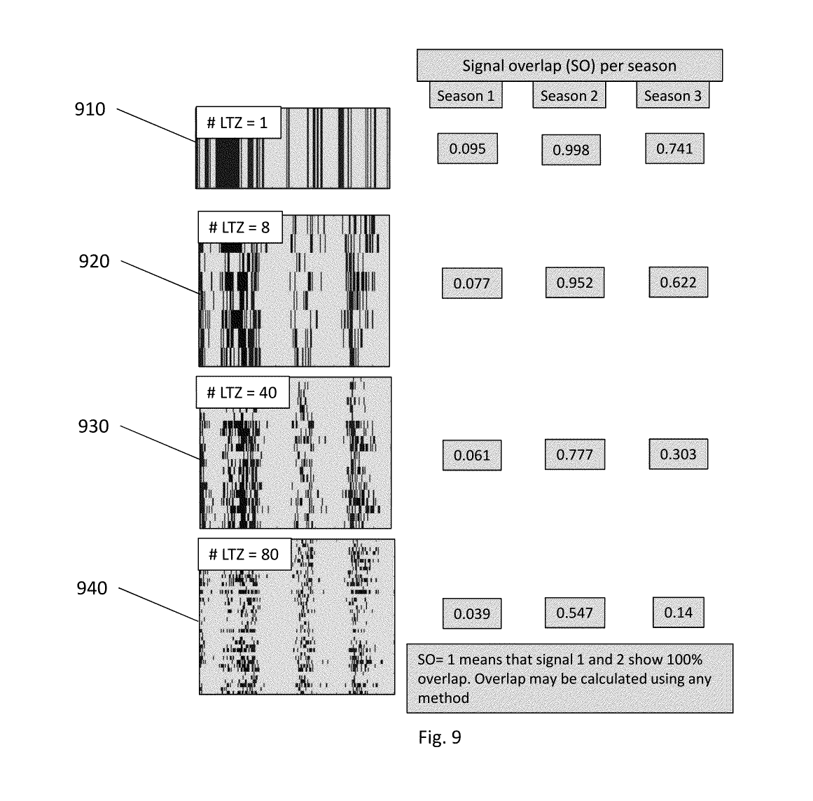

One parameter that affects the overlapping between the signals is the number of LTZs to which the area is divided. In some cases, the more LTZs there are, the better the signal separation is expected to be. Attention is drawn to FIG. 9 showing an example of the signal separation when dividing a given area to different numbers of LTZs, while considering the seasonal effect of certain diseases (as, for example, Flu is usually more common in the winter time). Image 910 shows the given area treated as a single LTZ. In this case, the signal overlap for season 1 is 9.5% (meaning that at 9.5% of the time window that is examined, there is an overlap between two or more signals, and there is no signal separation), for season 2 it is 99.8%, and for season 3 it is 74.1%. When dividing the same area to 8 LTZs, the signal overlap for season 1 is reduced to 7.7%, for season 2 it is reduced to 95.2% and for season 3 to 62.2%. When dividing the same area to 40 LTZs, the signal overlap for season 1 is reduced to 6.1%, for season 2 it is reduced to 77.7% and for season 3 to 30.3%. When dividing the same area to 80 LTZs, the signal overlap for season 1 is reduced to 3.9%, for season 2 it is reduced to 54.7% and for season 3 to 14%.

The extent of the overlap (between causing agent V1 and causing agent V2) can be calculated for example as follows:

overlap_{v1;v2}=crosscorr_{v1;v2}(0)/crosscorr_{v1;v2}(max)

where crosscorr_{v1;v2}(0) is the correlation at a certain point in time and crosscorr_{v1;v2}(max) is the maximal value in the relevant time period examined. The resulting degree of signal overlap per a given period varies between 0 and 1, where 1 indicates V1 and V2 completely overlap (same frequency), and a zero score indicates no overlap.

When looking at multiple LTZs the signal can be calculated for each LTZ and the overall signal overlap can be calculated as the weighted sum of the overlap in the individual LTZs. The weight used can be relative to the population size per LTZ, i.e. if the population size of one LTZ is NLTZ, then the weight (W) per area can be calculated as:

$${W}_{LTZ} = \frac{{N}_{LTZ}}{ {\sum }_{LTZ} N} , LTZ = 1 \text{:} k$$

And the resulting overall signal overlap is summed over all LTZs that comprise the area analyzed:

$${overlap}_{v 1 , v 2} = {\sum }_{LTZ}^{ } {overlap}_{v 1 , v 2} * {W}_{LTZ}$$

The signal overlap in each LTZ, and consequently the overall ratio in the entire area are bound between zero (no overlap) and one (complete overlap).

Returning to FIG. 5, Signal continuity (SC) refers to continuity in time, by which we refer to the dynamics of some causing agent between times t and t plus delta, where this time span is directly linked to the timeframe of analysis used by the system for such causing agent. Continuity may be calculated using standard statistic tools or simply by calculating the conditional probability of an event at time t plus delta given an event at time t. The SC measures the ‘predictive power’ of the LTZ. given LTZ X being associated with a given causing agent during the timeframe before diagnosing a patient and the patient was within LTZ X, what is the probability of the patient providing a positive result for the given causing agent. Consider for example the typical shape of ‘the flu’ (any influenza like illness) in a large area—in this example the number of events at time t clearly correlates to past events (as can be appreciated given the catalytic nature of the infection process), i.e., the number of events at time t may be approximated at a certain level of accuracy from number of events at times t-1, t-2, t-3 etc.

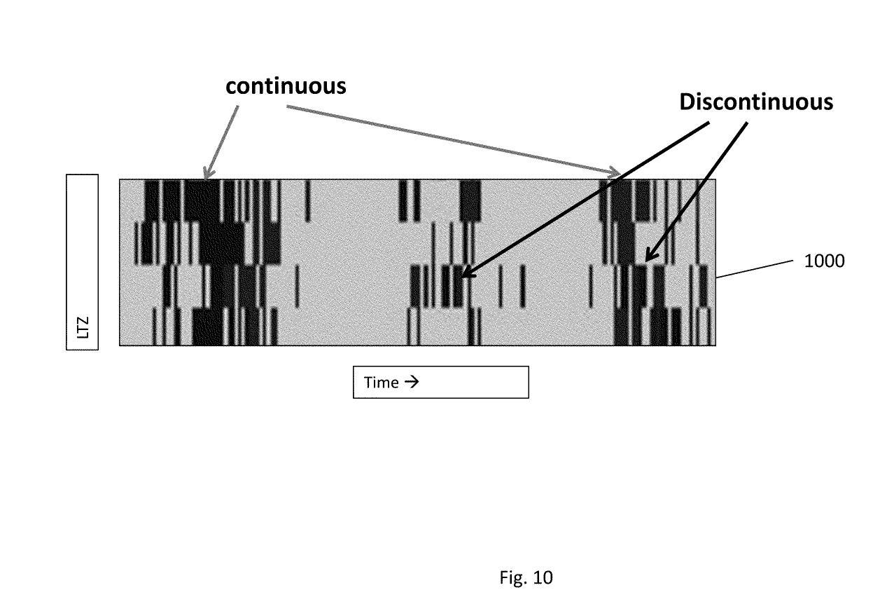

Attention is drawn to FIG. 10 showing an example of signal continuity. Image 1000 shows the signals of two causing agents at a given time frame. In the areas marked as continuous, there is dominant causing agent for a relatively long time period, for example in comparison to the areas marked as discontinuous in which there is a more often shift between two or more dominant causing agents at a certain portion of the time frame. The thicker the lines (associated with a certain causing agent) are, the more continuous the signal is at the corresponding time frame.

Returning to FIG. 5, Spatial Distribution Test (SDT) is a combination of previous tests with an added random element (e.g. associating one or more patients originally associated with certain LTZs to other LTZs respectively). After adding the random element, the Signal Separation and Signal Continuity are tested again, where results outperforming the original LTZs indicate that the chosen LTZs are poor, and results underperforming the original LTZs indicate a correct LTZ choice. By random elimination/manipulation of LTZ choices we can identify ‘hotspots’, LTZs with unusual disease activity, etc. Furthermore, by comparison to random LTZ sets critical areas as well as the ‘general pattern’ of the causing agent can be determined, specifically, ‘community’ vs. ‘facility’ distribution, where a facility distribution assume unique sources (e.g. hospitals) and a community patter assumes LTZ based distribution with distance based but not random LTZ choices.

According to some examples of the presently disclosed subject matter, following clustering and grading of the clusters, a check can be performed whether an end criterion/criteria is/are met (block 530). In some cases, the end criterion can depend on the grading of the clusters only (e.g. so that the overall number of clusters having overlapping pathogens is minimal or below a certain threshold, or that the overall number of overlaps between pathogens within the clusters is below a certain threshold, etc.). In such cases, when the grading of the clusters meets the threshold requirement—the end criterion is met. In some cases, alternatively or additionally, the end criterion is met when each individual cluster meets a certain threshold (e.g. so that the overlap of causing agents within each cluster is below a certain threshold). In other cases the end criteria can alternatively or additionally depend on the status of the iterative process used for calculating the number of clusters as indicated above. In such cases, the end criteria are met when the last iteration is performed (and the grades exceed the threshold). In some cases the number of iterations can be pre-defined, and in other cases it can be dynamic and/or determined by user input manually, e.g. the iterations can repeat until degradation in the grades is identified or until the user is “satisfied” with the outcome (e.g. predictive accuracy). In some cases the end criteria can include a maximal number of clustering iterations, e.g. for a clustering attempt to a certain number of clusters (e.g. a pre-defined number of clusters or a number of clusters of the iteration currently performed, e.g. when the system calculates the number of clusters or when the system clusters to two or more groups of clusters). Another criterion could be the predictive accuracy of an algorithm that makes use of these LTZs or the ‘difference’ between the accuracy of an algorithm using k1 LTZs to one using k2 LTZs (normally k2<k1).

If the end criterion/criteria is/are not met—the process returns to block 510, and in some cases only the clusters that did not meet the end criteria will be re-clustered and/or treated as ‘lower accuracy’ areas/individuals, i.e. predictions made regarding these areas/individuals will be assigned a lower level of ‘confidence’ and/or data obtained regarding them would be marked as ‘suspect’. If the end criterion/criteria is/are met, a check can be performed whether cluster improvement is required (block 540). If not—the clusters can be stored, for example on data repository 210, and the process ends (block 560). If however improvement is required, e.g. as their grade is below a certain threshold, the clusters that require improvement/optimization can be re-clustered independently of the other clusters (block 550) following which the clusters can be stored, for example on data repository 210, and the process ends (block 560).

It is to be noted that in some cases the LTZs generation process 500 can generate LTZs in several resolution levels, e.g. by clustering the given area based on one or the more given pathogens to a first number of clusters X and to a second number of clusters Y and to a third number of clusters Z, where X<Y<Z. Although in the example three levels of resolutions have been disclosed, this is not limiting and any number of levels of resolution can be generated. Utilization of the LTZ resolution levels is explained herein.

It is to be further noted that in some cases, authorized personnel (e.g. MDs), can alter the LTZs, for example by combining two or more LTZs, splitting one or more LTZs to two or more new LTZs, etc.

It is to be noted that, with reference to FIG. 5, some of the blocks can be integrated into a consolidated block or can be broken down to a few blocks and/or other blocks may be added. Furthermore, in some cases, the blocks can be performed in a different order than described herein (for example, block 540 can be performed before block 530, etc.). It is to be further noted that some of the blocks are optional. It should be also noted that whilst the flow diagram is described also with reference to the system elements that realizes them, this is by no means binding, and the blocks can be performed by elements other than those described herein.

Attention is drawn to FIG. 6, showing a flowchart illustrating one example of a sequence of operations carried out for providing a diagnosis, in accordance with the presently disclosed subject matter.

According to some examples of the presently disclosed subject matter, System can be configured to perform a diagnosis process 600 (e.g. utilizing LTZs generation module 250). It is to be noted that the diagnosis process 600 can be performed: (1) by internal servers 102 within a certain facility, e.g. for internal use, and/or (2) by external servers 104 within a certain facility or externally thereto, e.g. for external use, e.g. by patients treated within the facility or otherwise associated with the facility (e.g. patients residing within a certain area defined to receive services from a certain facility, etc.), and/or (3) by inter-facility servers 108, e.g. for a population associated with more than one facility (e.g. at least for a first population associated with a first facility and a second population associated with a second facility) and/or by user device 106.

According to some examples of the presently disclosed subject matter, the server 200 that executes the diagnosis process 600 can be configured to obtain (e.g. by retrieving from data repository 210) patient-related information (block 610). The patient-related information can include information that enables the System to identify the patient and/or to determine the LTZ with which the patient is associated (e.g. location information such as home address and/or location history (acquired e.g. via user device 106 tracking) and/or any other location determination enabling data such as data received from Social Networks (e.g. Facebook's Check-in, etc.)). The patient-related information can optionally further include information relating to symptoms the patients is experiencing (provided for example by the patient and/or any other person via user device 106) or an indication of a basic disease type.

Based on the received data, the System can be configured to attempt to associate the patient with a corresponding LTZ. The corresponding LTZ is an LTZ from a group of LTZs that relate to causing agents that cause the symptoms the patient is experiencing, and that encompasses the identified patient (or the location of the identified patient).

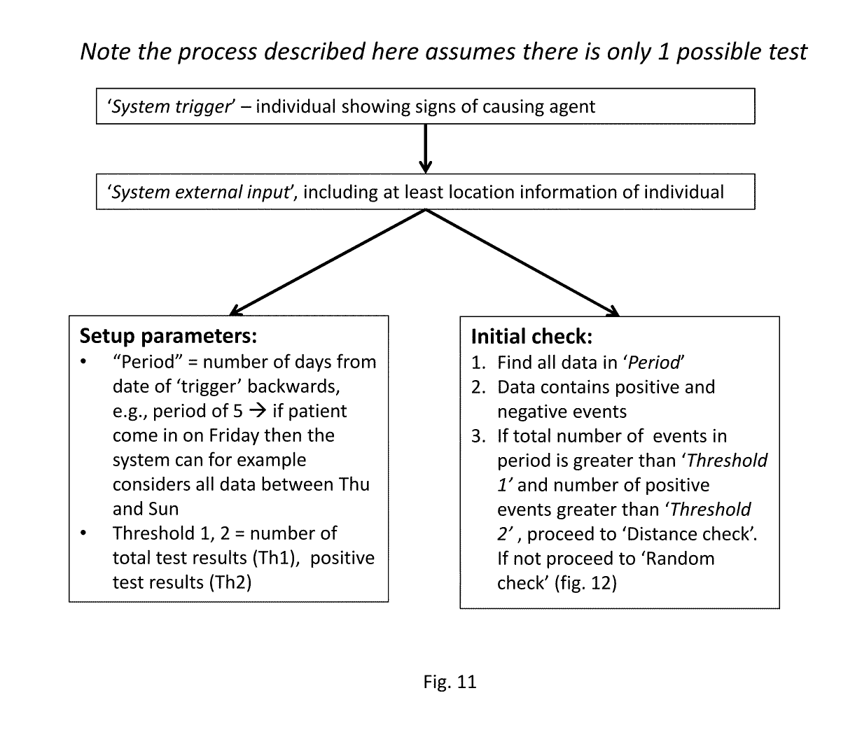

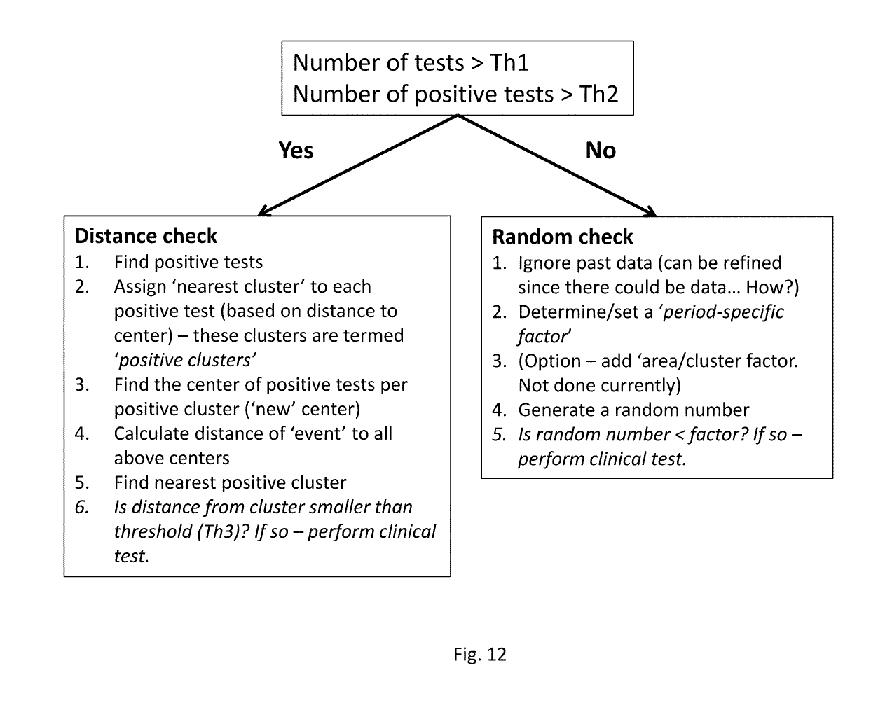

After associating the patient with the LTZ, or when no matching LTZ exists, the System can be configured to check if clinical tests of the patient are required (block 620). Clinical tests can be required for example (1) when no matching LTZ exists, and/or (2) when the matching LTZ does not comprise sufficient information in order to diagnose the causing agent with a sufficient level of accuracy, and/or (3) randomly, in order to enhance/improve the data based on which the LTZs are clustered, (4) when a certain time period past since the last patient was clinically tested, (5) when the probability to receive a positive test result exceeds a certain threshold (the likelihood can be calculated for example based on distances of the patient from other patients tested positive for certain causing agents), (6) in accordance with the algorithm described in FIGS. 11 and 12, etc.

In some cases, ‘Optimized sampling process’ (OSP) can be applied. OSP is a general algorithmic approach to conducting spatial sampling of causing agent(s) based on maximizing the amount of data per area while avoiding unnecessary clinical tests (spatial testing redundancies) whose effect on the accuracy of the diagnostics process is negligible. While research into spatial sampling is not at all new and various algorithms and methodologies exist for many types of data (e.g. Sampling theory, Geo-Statistics etc.) and may be akin to risk based sampling approach described in literature in the sense that some of the logic may overlap. Problem addressed: Given area A to be monitored, when, where and how many ‘clinical samples’ (e.g. qPCER applied to RNA/DNA collected via a nose swab) are needed in order to ‘cover’ area A for causing agent X with a minimal degree of confidence C (in some cases C can be pre-defined). ‘Cover area A’ may be defined as appropriate given the technical aim; in this example we focus on the ability to discern between causing agents X, Y and UA, so here specifically the technical coverage goal would be: ‘cover area A’=have a sufficient number of samples/data per LTZ to allow diagnosis based on the LTZs to perform with a certain minimal accuracy (in some cases the accuracy itself is defined on a per-case basis). In some cases, information of the accuracy level of various clinical tests can be taken into account as well (as in some cases some clinical tests are not 100% accurate, and in some cases they can be very inaccurate, e.g. only 50% accuracy, etc. and the result can be a false positive or a false negative).

In context (LTZs), one practical way to apply OSP to surveillance/diagnosis is in the attempt to always use the optimal level of LTZ resolution, i.e. the LTZ number and specifics (there are potentially numerous ways to create 24 LTZs, some good, other bad) that provide the highest score for a given set of “qualifiers”. Assuming for simplicity that this “optimal set” is defined for a sufficiently long period (i.e. and e.g., doesn't change every day) and give the specific aim e.g. of differentiating between pathogen A and B using some algorithm (e.g., the one from the PAPER), then one potential OSP approach would be one that recommends testing in such a manner that will provide enough A and B testing per LTZ from said set (as much as possible, in absence of patients from some LTZ testing is not possible, or at least not straightforward).

If clinical test is required—the system can provide appropriate output to the user device 106 (e.g. “clinical test required”) (block 630). If not—the system can perform diagnosis based on the LTZ (block 640). As each LTZ is associated with a causing agent, the diagnosis can be that the patient is infected with the causing agent associated with the LTZ with which the patient is associated.

It is to be noted that in some cases associating an LTZ with a given causing agent out of two potential causing agents (e.g. causing agent V1 and causing agent V2) can be in accordance with the following formula (also referred to herein as “disease ratio”:

$${Ratio}_{v 1 , v 2} = \frac{{DS}_{v 1} - {DS}_{v 2}}{{DS}_{v 1} + {DS}_{v 2}}$$

Where DS is disease signal as explained above with reference to FIG. 4. In case Ratio_{v1,v2}<0, the LTZ can be associated with causing agent V1; in case the Ratio_{v1,v2}>0, the LTZ can be associated with causing agent V2 and in case Ratio_{v1,v2}2=0, the LTZ is not associated with any of causing agent V1 or V2. It is to be noted that the disease ration can also be used to grade the LTZs (e.g. as part of block 520).

In some cases, the diagnosis can be additionally based on information of association of the patient with a certain Ring. A Ring in this context can be is defined as a group of people whose interaction with a given pathogen (or set of pathogens) results in a similar set of one or more symptoms. A more detailed explanation about Rings is provided herein, inter alia with reference to FIG. 7. Having information of the patient's Ring association (data on which may be obtained independently of specific facility data, e.g. via reporting individuals in the community, described also below) can enable for example validation of an LTZ based diagnosis or any other kind of diagnosis, as, for example, the Ring can provide information of the expected patient's symptoms when infected with a certain disease, and if the actual symptoms the patient is experiencing do not match the expected symptoms in accordance with the ring, there is a potential mistake/error in the ring assignment and/or the diagnosis itself. This may be of particular importance given the substantial frequency of “false-negative” clinical test results (e.g. with rapid tests for influenza false negative rate can be as high as 50%). In such cases, of potential mistake/error in the diagnosis, repeating the clinical tests and/or performing other clinical tests may be required. In some cases the ring can also provide information about expected reaction of members of the ring to one or more types of treatment/interventions (e.g. to a certain medication or to a certain mix of medications, etc.). Such knowledge can be utilized in order to recommend a certain course of treatment that is expected to perform better than the other courses for treating the diagnosed causing agent. Similarly, since in such cases the response to treatment is within the ring definition, a response different from expected may indicate either the ring was erroneously assigned, or, importantly, may indicate the existence of another, hitherto unidentified disease cause (pathogen or other, e.g. autoimmune disease).

In some cases, the diagnosis can be provided to the user as output (block 650), and in some cases it can also be stored on the data repository 210 (in association with the patient, the diagnosis time, and optionally also data relating to the patient's symptoms caused by the diagnosed causing agent).

It is to be noted that in some cases, more than one group of LTZs exists for causing agents that cause the symptoms the patient is experiencing, where each group comprises a different number of LTZs. In such cases, the system can associate the patient with the corresponding LTZ within each group of LTZs and select the one having the highest calculated grade to be used as basis for the diagnosis.

Alternatively, the system can assume that the more LTZs comprised within a group of LTZs—the more accurate the group is (while noting that this assumption is not necessarily correct, as for example, a certain patient can belong to a first LTZ covering a first area in the first group of LTZs comprising a first number of LTZs, and to a second LTZ covering a second area in a second group of LTZs comprising a second number of LTZs, the second area being larger than the first area and the second number of LTZs being larger than the first number of LTZs). The system can optionally first try to diagnose the patient based on the group of LTZs that comprises the largest number of LTZs, and only if the LTZ associated with the patient does not enable diagnosis or does not comprise enough data to provide accurate (e.g. according to a threshold) diagnosis—pass to the next group of LTZs. The system can repeat the process until the reaching the group of LTZs that comprises the lowest number of LTZs, and if such group does not enable diagnosis—perform block 630. In some cases this process can be performed as part of block 615 and/or as part of block 640.

It is to be noted that, with reference to FIG. 6, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Having described the diagnosis process 600, it is to be noted that clinical tests designed to identify e.g. a particular pathogen (e.g. clinical test for Influenza type A) may be quantified using ‘sensitivity’ and ‘specificity’. Sensitivity refers to the proportion of ‘carriers’, i.e. individuals hosting the pathogen (infected) that are identified as such using the test. For example, a test may have a sensitivity of 85%, implying that out of 100 carriers 85 will be identified as such and 15 will be incorrectly diagnosed as ‘negative’ for the pathogen tested for.

The underlying causes for these false negatives may be insufficient detection sensitivity given a sample containing pathogen material, but it may also result from the pathogen not being present in the clinical sample tested. In the first case a more sensitive test may detect the pathogen (e.g. PCR test is more sensitive than a rapid antigen test). In the second case even the most sensitive test will fail to find the pathogen, as it physically not present in the sample.

Using the methods described here, e.g. LTZ methodology for example, accurate predictions are generated from among other, clinical test data. This data may contain false-negative test results, which may lead to a diagnostic error. The system may reduce this error rate since it is an independent diagnostic step. Therefore the system could detect these false negative e.g. by comparing expected outcome (e.g. according to the diagnosis process 600) to test result.

It can then prompt to ‘double check’ the samples identified as negative using molecular methods. Note the described logic may be similarly applied to ‘specificity’ in situations where the rate of ‘false positives’ is higher than desired. Note also such data may be used to quantify the de-facto error rate of specific clinical tests, if the name of the test is known, e.g. test X by company Y.

Turning to FIG. 7, there is shown a flowchart illustrating one example of a sequence of operations carried out for creating additional data enabling disease monitoring and identification, in accordance with the presently disclosed subject matter.

According to some examples of the presently disclosed subject matter, system can be configured to perform an additional diagnosis data creation process 700 (e.g. utilizing rings generation module 270). It is to be noted that the additional diagnosis data creation process 700 can be performed: (1) by internal servers 102 within a certain facility, e.g. for internal use, and/or (2) by external servers 104 within a certain facility or externally thereto, e.g. for external use, e.g. by patients treated within the facility or otherwise associated with the facility (e.g. patients residing within a certain area defined to receive services from a certain facility, etc.), and/or (3) by inter-facility servers 108, e.g. for a population associated with more than one facility (e.g. at least for a first population associated with a first facility and a second population associated with a second facility).

The server 200 that executes the additional diagnosis data creation process 700 (that can be an internal server 102, and external server 104, or an inter-facility server 108), can be configured to obtain (e.g. by retrieving it from the data repository 210) diagnosis data including (a) clinical test results data and/or diagnosis data obtained using the diagnosis process 600 and/or information about diagnosis of a causing agent infecting a patient obtained from any other source, (b) an indication of the diagnosed patient (e.g. a national identification number), and (c) information relating to the symptoms (e.g. one or more physical manifestations) the corresponding diagnosed patient has experienced when infected with the pathogen (e.g. received from the patient or from any other user operating the system) (block 710).

In some cases, one or more of the following can also be obtained: (1) data relating to the date and time the diagnosis was performed (e.g. a timestamp), (2) data relating to the corresponding patients spatial positions (such data can include an indication of the patient's home address and/or work address and/or spatial information about a plurality of locations of the patient within a certain time window that can be collected e.g. using the patient's user device 106 periodically and/or continuously, etc.), (3) data about the response of the patient to one or more treatments following the diagnosis, (4) patient characteristics/traits such as age, height, weight, blood type, blood pressure, gender, etc.

Utilizing the data obtained in block 710, the server 200 that executes the additional diagnosis data creation process 700 can be configured to generate rings (block 720).

A “Ring” is defined here in the most general sense as any set of qualities/parameters (e.g. causing agent, gender, age, medication taken, weather the patient sought treatment, disease type, symptoms data, vaccination/infection history, stress levels, physical locations data, movement level, interaction level with other people, nutritional intake, family status, hobbies, particular activities such as sport activities, pregnancy, underlying health conditions, environmental conditions, air pollution level, rural vs. urban areas, allergens, hygiene level, etc.) that can be used to divide groups of patients; a simple and straightforward example of such a set is “people that tested positive for influenza”, which without using any other discerning qualities is the entire population that was tested positive for any kind of influenza at any time. This however is such a wide definition, that it may be of very limited utility in practice. A more focused definition could be the group of people testing positive for influenza in some facility during a time-period, which in this case would be exactly DS(influenza, facility, time-period) as defined. If these people also came from the same LTZ, then it is the DS of influenza, associated with hospitalization (since these people were tested only after coming to facility) in that LTZ. The people (in that LTZ) that were infected during the same period but did not seek medical help (at least not in said facility), which defines/separates these from the ones that did. Another simple distinguishing quality is the particular type of influenza identified at any resolution, e.g. H1N1 vs. other subtypes, or particular strains of H1N1 for further refinement.

In a less simple way a ring may comprise a group of people showing similar symptoms when infected with a given causing agent. The rings can be generated by clustering (e.g. similarly to the clustering of the LTZs, but utilizing different data) a given population into groups based on distances between vectors where each vector represents the qualities/parameters (including at least symptoms experienced by the corresponding patient when infected with a given causing agent). In some cases information relating to the generated rings can be stored on data repository 210. In using such “symptom vectors” there is no reason to consider the relative importance (weight) of each symptom as equal for purpose of clustering or other (e.g. assigning a patient with a particular ring). Note these vectors (comprising data from any quality as defined above) can be separated/clustered using the same methodology described for LTZs. That is, the clustering would be such that the distance between the vectors in the same ring would be much smaller than the distance between vectors from said ring and vectors from any other ring. Similarly, a plurality of ring groups can be generated, each comprising a different number of rings, as described for LTZs. Also, the ring itself may be graded (again like LTZs) and this grading can be used for directing and refining ring selection.

In some cases, the server 200 that executes the additional diagnosis data creation process 700 can monitor (e.g. continuously, periodically, following a triggering event, etc.) if update of the rings is required (block 730) and if so—return to block 710. Note that “rings” may be graded using similar methodology to that presented regarding LTZs, e.g. treating each symptom vector as some simple/complex “signal” and then maximizing the degree of signal separation (SS) of two or more such signals.

In some cases, periodical update of the additional data enabling disease monitoring and identification can be required. Additionally or alternatively, update of the additional data enabling disease monitoring and identification can be required when new clinical test results and/or diagnosis results in accordance with the diagnosis process 600 are obtained from various reasons. It is to be noted that these are mere examples of events that trigger update of the additional data enabling disease monitoring and identification and other events can trigger the data update.

In some cases all or part of the following definitions are relevant with respect to the rings:
1. ‘Symptoms’ are defined here as one or more physical/mental manifestations (e.g. stomach pain, anxiety etc.). It is to be noted that data regarding both may be obtained via other/external data sources, such as “mood detection software”, social networks, etc.
2. ‘Symptoms+’ may comprise traditional symptoms but also non-traditional qualities, such as location history or patient group traits such as e.g. age, gender, disease history, immunization/drug history, etc. Location history can be, for example, information of locations visited by the patient in the relevant time-frame. Locations visited may represent physical locations per se (as in ‘Venice beach’) or network locations, such as interacted with X and Y, where X and Y represent a potential source of some disease. A potential source may be actively infected or not—the critical point is that it may carry/transmit a disease causing agent. Epigenetic traits, such as epigenetic modifications (e.g. DNA methylation) and/or initial infecting seed size/genetic compositions of the invading pathogen (in cases where pathogen creates, via genetic diversity and/or any other genetic diversification mechanism, a pathogen ‘quasi-species population’ or ‘heterogeneous swarm’ etc.) are another example of a quality that may be included in the symptom+ definition
3. Symptom sets: a symptom set is one or more symptoms that are associated with a host-pathogen interaction. A particular disease causing-agent may cause a range of symptom sets and be associated with multiple Rings.
4. A particular symptom set is not random (while may have a random element to it) and may usually be deduced given complete information, such as the particular causing agent variant (genetic or epigenetic traits), environmental conditions, and traits of the host, such as infection history, physical state, anxiety, age etc., defined under patient group.
5. A ring may be defined with and/or without molecular level identification. e.g. the ring definition may include traditional molecular-level data (e.g. Flu H3N2, Brisbane 2004) or not.
6. Rings, unlike LTZs, are not necessarily limited to a single locale and as such a ring defined in one area may be used in any other area(s). In this respect, the physical movement of a “ring member” (which is also a carrier) from area A1 to A2 may lead to dynamics congruent with said ring in area A2, (assuming the describing vector is matched in A2—i.e. similar environmental/human conditions)
7. As an extension, given sufficiently accurate ring characterization, a patient's diagnosis, prognosis and treatment options may be deduced without molecular level (clinical) testing.

While rings may be defined using any parameter, some parameter choices in defining rings are more useful than others. Throughout this text when reference is made to any use associated with rings it can refer to the most appropriate per case ring definition, without limiting to one or another. As stated above, Rings are not necessarily limited to a particular space or time. In some cases, each ring must contain a minimal number of cases. There may be variations within the behavior of elements/members of a ring. In some cases, when variation within a ring is consistent and/or significant in terms of system parameters, a ring may merge with another ring or rings, diverge into two or more rings, and/or evolve.

It is to be noted that, with reference to FIG. 7, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

In the community there is very little methodology in terms of symptoms-checking. In facilities the methodology is more structured and there are several basic symptoms routinely checked in almost all standard infection cases (i.e. checking-for/diagnosing common infectious diseases). However, even when symptoms are collected professionally in clinical settings, in the vast majority of cases an identification of the actual causing agent requires a specific clinical test and in the absence of such a test diagnosis can in some cases only differentiate between very general groups of potential causing agents, e.g. between bacterial and viral type of infection.

Two extreme examples of this limitation are Ebola and HIV infections; in both cases the initial symptoms are more or less similar (although not identical) and generally resemble an influenza infection. It should be noted that today it is possible to clinically test for both pathogens, which is indeed the only way to get a diagnosis before the situation develops beyond mere flu symptoms.

One current de-facto solution regarding e.g. Ebola is to “isolate” any persons showing flu symptoms in areas where there are known/suspected Ebola presence. This is however extremely inefficient as most cases are indeed unrelated and in fact the isolation (which occurs often en mass) by itself may serve as a hotspot of transmission between the very few infected with Ebola and a crowd of people sick for other reasons.

Moreover, it is well known that the level of a person's “infectivity” (or susceptibility) and the displayed symptoms (up to a-symptomatic) are highly individual. Yet these are not random, although they likely have a random element to them. For example, a relation between stress level and susceptibility to infection is known, as well general differences in symptoms displayed between different age groups. Another example is immunity; a group of people that were exposed to a certain pathogen, could respond to “similar pathogens” (antigenically close) in a distinctly different pattern from that observed in a group that was not exposed in such manner.

The concept of Ring addresses these problems (see above) by identifying groups that, statistically, would show great similarity in one or more aspects relevant to the interactions of host and pathogen, as well as any aspect of transmission dynamics (infectivity level, length, susceptibility, response to interventions etc.). This is done via use of more accurate analysis of the present pathogens (e.g. described in LTZ methodology) and also by treating a wider set of qualities as an inherent factor in infections, allowing higher-resolution, dynamic description of existing Rings.

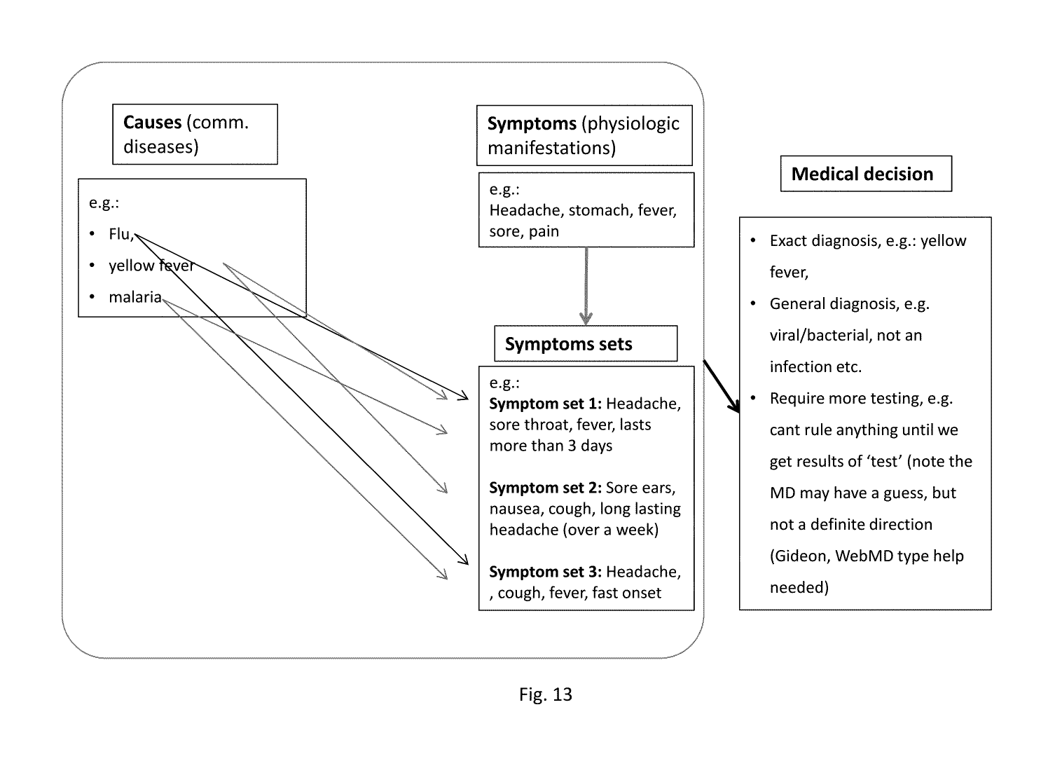

Looking at FIG. 13, showing the medical decision process of the prior art, it can be appreciated that in some cases various diseases (traditional definition) may be associated with different symptoms sets (and conversely, symptom sets are not unique), and that these symptom sets are essentially “static”, e.g., the symptomatic definition of flu infection has remained essentially the same over the last century. It is to be noted that symptoms and causing agents are rarely qualitatively tested/updated and there are no real time association/update systems or methodologies (as described here). In some cases, a medical decision is made based on the symptom set reported by the patient.

It can be appreciated that many of the qualities termed here symptom+ are not routinely collected today. In addition, the range of symptom+ can be much wider than that of traditional symptoms, making the “symptom collection” process long and complicated to use.

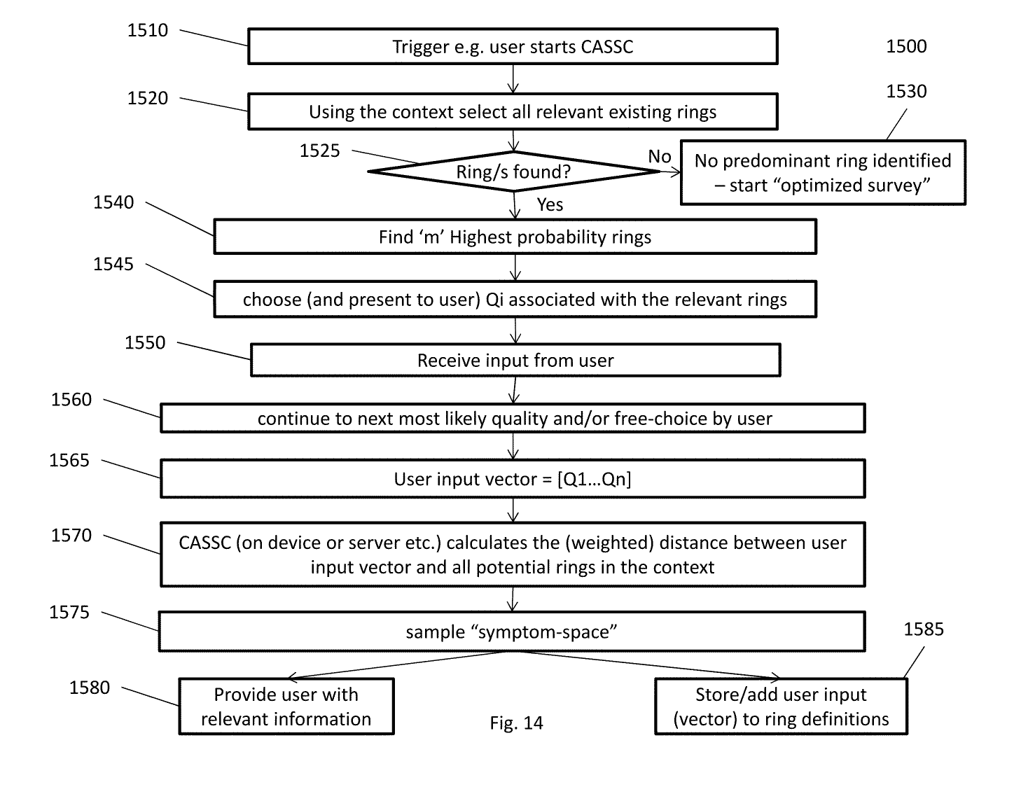

One exemplary solution to the challenges described above can be applying a Context-Aware Systematic Symptom Checker (CASSC) process 1500 (e.g. utilizing CASSC module 280), shown in FIG. 14. CASSC can be configured to connect between a specific patient/user and the range of symptoms/qualities included in relevant ring definitions (e.g. the rings with which the patient/user is associated). In some cases, the CASSC process 1500 can include identifying the most prominent symptoms in the most likely rings (with which the patient/user is or should be associated), based on user location and profile (or only location), and receiving input from the user (that can be the patient and/or any other person operating the system such as an MD) whether or not he is experiencing such symptoms. E.g. given that in the user's associated LTZ/ring the most frequent symptom was cough (in general or in the user's patient group, if exists), then “cough” may appear as the first choice presented to the user to indicate whether or not this symptom is experienced by the patient (that, as indicated above, can be the user).

After the first user input (in response to the first presented symptoms) is received by the system, the next symptom set is selected, and then the next and so on until the process ends. The sequence of symptoms presented, even when used to identify the same pathogen, is dynamic and influenced by user input and a variety of other factors, such as user patient group and any other data the system considers a ‘quality’ in constructing rings, location etc. Note the sequence will also vary with the aim for which CASSC is triggered, e.g. if triggered by user the sequence will be optimized for most accurate/reliable diagnosis and/or identifying factors alleviating symptoms etc. However, the aim may also be improving the definition of relevant rings (those associated with user), testing validity of any related hypothesis (see e.g. block 1660) etc. The sequence of potential symptoms presented to user is thus context-dependent/aware. Without taking into consideration all aims, we now provide an example of the basic process by which the next symptom set is selected.

At each symptom-check step and next symptom set selection steps the user input is added to a growing “user input vector” similar in structure to the vectors used in ring definition (V=[W1*Q1 . . . Wn*Qn]), containing ‘n’ weighted elements based on the n symptoms presented and corresponding user input (e.g. his response to the question whether he is experiencing the corresponding symptom or not). At each step the system calculates the distance between user vector and existing rings (calculation limited to the ‘n’ elements in user response, note at each step “n(step j)=n(step j)+1”). The distance calculation can be similar to the one used in the ring/LTZs generation process: V1 and V2 are exemplary vectors defining 2 rings, each has n elements. Assuming for sake of example that n=2, the distance between V1 and V2 can be for example Distance=square root of [(V1(1)−V2(1))̂2+(V1(2)−V2(2))̂2)] (standard Euclidean distance), but any other way of calculating such distance may be used. When adding the weights (W) into the calculation each “element” is multiplied by the weight associated with the element, where the weights may be the same across all the relevant rings or ring-dependent.

Eliminating potential rings is based on exceeding some minimal threshold distance, i.e. if distance(user, ring)>threshold and the other elements in said ring can not make this distance smaller than threshold e.g. even if all remaining (weighted) qualities are matching the distance is still greater than threshold), then the ring is removed from the current potential rings with which the patient may be associated.

The remaining rings (i.e. those not removed) are further explored, where the sequence of suggested symptoms is dictated e.g. by their weights, i.e. from the “closest ring” choose the remaining symptom of the highest weight or the most “distinguishing” symptom, i.e. a symptom that (given a positive/negative response) can help eliminate the maximal number of the remaining potential rings.

The process may end when only one ring remains which is sufficiently close to user vector or when additional user response is not useful in the context (i.e. the “aim” set by system, see above), e.g. will not affect the conclusion, whether the conclusion is a single ring or a list of rings, which do not differ between them in any of the remaining symptoms/qualities used in those ring definitions. Note the end of the process may implicate a specific causing agent, but would not necessarily do so, since the rings are not necessarily identified with a single causing agent.

If no ring choice can be made with sufficient confidence a new tentative ring can be defined based on existing input (and stored) and its definition (e.g. relative weights, additional qualities) may be developed as more instances are reported. In absence of such these tentative rings may be stored indefinitely.

Note that rings may be manually defined and/or modified, e.g. by medical staff that may add clinical test results to an existing ring, thereby associating it with one or more pathogens/conditions, or from users manually selecting some or all symptoms when interacting with CASSC. These user-defined rings may be used/treated as any other ring e.g. based on patients' responses. Similarly, a user may query the ring database (given access) in order to explore/research past diagnostic decisions etc.

The relative weights in a given ring may be modified as more data become available (i.e. more associated cases). Also, additional qualities may be added to a ring, either manually or via the CASSC system exploring the “symptom space” of a ring, e.g. once a patient is assigned a ring based on the qualities of that ring, the CASSC system may survey other qualities not currently associated with said ring (either randomly, manually or exploring qualities from “related rings”, where relatedness may be based e.g. on the distance between the rings).

As a result of this, rings may evolve (modifications to weight, additional qualities that maintain the ring), diverge, e.g. when a ring is divided into two (or more) significantly more homogeneous rings (similar to methodology explained for the LTZ resolution level) or merge, e.g. when additional qualities (or more patient data) lead to a smaller than threshold (e.g. the threshold used in clustering the qualities) distance between the two rings. Note these processes are not mutually exclusive, e.g. two rings may evolve and merge, yet some members of the original rings would be removed. Therefore CASSC makes use of the exiting ring definitions but also helps refine and modify said definitions.

Returning to FIG. 14, the CASSC process 1500 can starts from a trigger (block 1510), where this trigger may be user/patient starting CASSC or CASSC prompting a user to use CASSC—this automatic trigger may be employed e.g. if the system suspects the user/patient may provide information that can improve ring definitions. The trigger may also be from a facility to a specific user or a group of users, e.g. to keep track of discharged patients.

The system receives from user context information (block 1520), such as current location or a location history if data exists, and other patient characteristics if available (age, gender, vaccination history, etc.). Next the system checks if there are any relevant/existing rings in said context (block 1525)—if there are none (block 1530) it will start symptom check either from user input (e.g. user selects symptoms from list) or from presenting more common symptoms in the nearest rings or if no rings exist/existed in context, then just common symptoms, i.e., qualities found most often in all past and present rings. Note that a ring may be considered relevant if it exists in area or predicted to (i.e. existed or expected to spread) and if it is consistent with patient information. For an anonymous user, since no information is known (not even age or gender) all nearby rings are relevant. In the absence of location, all rings, anywhere and anytime that are predicted to exist may be considered relevant.

If there are relevant rings (block 1540) then the system will present to user the “highest probability rings”, where these can be e.g. the most frequent rings in the context. In certain situations the system may choose these “first rings” based on other parameters, such as a combination of current ring frequency and the urgency of diagnosis (e.g. rings with pandemic potential) or in order to achieve some other goal in the process, such as expanding/refining/consolidating ring definitions.

Each of the selected rings contains a list of qualities/symptoms, each quality associated with a weight. When presenting the initial symptom set the system may choose (block 1545), from each ring, quality (Qi) with the greatest associated Wi. It may choose other parameters in this decision, such as the qualities Q that would help distinguish most effectively between the rings, where effective may be the fastest route (minimal number of qualities necessary to make a decision) or any other parameter that can affect this process.

Upon receiving user input (block 1550), e.g. confirming (or not) any number of suggested symptoms (note the system may allow a single choice only), the system repeats this selection process using the available qualities minus those already presented (block 1560); it may present the same qualities more than once for confirmation and/or any other reason, e.g. user consistency. After each step the distances between the user's input vector (block 1565) and the rings are calculated (block 1570). As described, when the distance to some/any ring is deemed too great for other qualities to reduce sufficiently, the ring is removed from the list of likely associated rings.

The system may “spike” the queries with qualities not present or critical in the rings surveyed (block 1575)—this may be done either to explore potentially associated qualities that were not previously defined in the system. It may also perform this step (block 1575) in order to verify that rings that are not present in the set were not erroneously eliminated, or other related reasons.

The output to user/patient will vary (block 1580), but typically it would be relevant to the need, i.e. for diagnosis it will attempt to provide a causing agent, prognosis, most effective treatment options, etc. It may also suggest testing for specific pathogen or collecting symptoms not collected in particular case, if these would be useful in the context of the CASSC process 1500 or ring definitions. The data generated by the CASSC process may then be stored and/or added to ring definition process (block 1585). Data may be assigned a degree of reliability, e.g. if provided by a working MD it may be more reliable. Other degrees may be used such as the consistency of user responses (where this consistency and or reliability may be assigned using standard methods used in surveying or other fields).

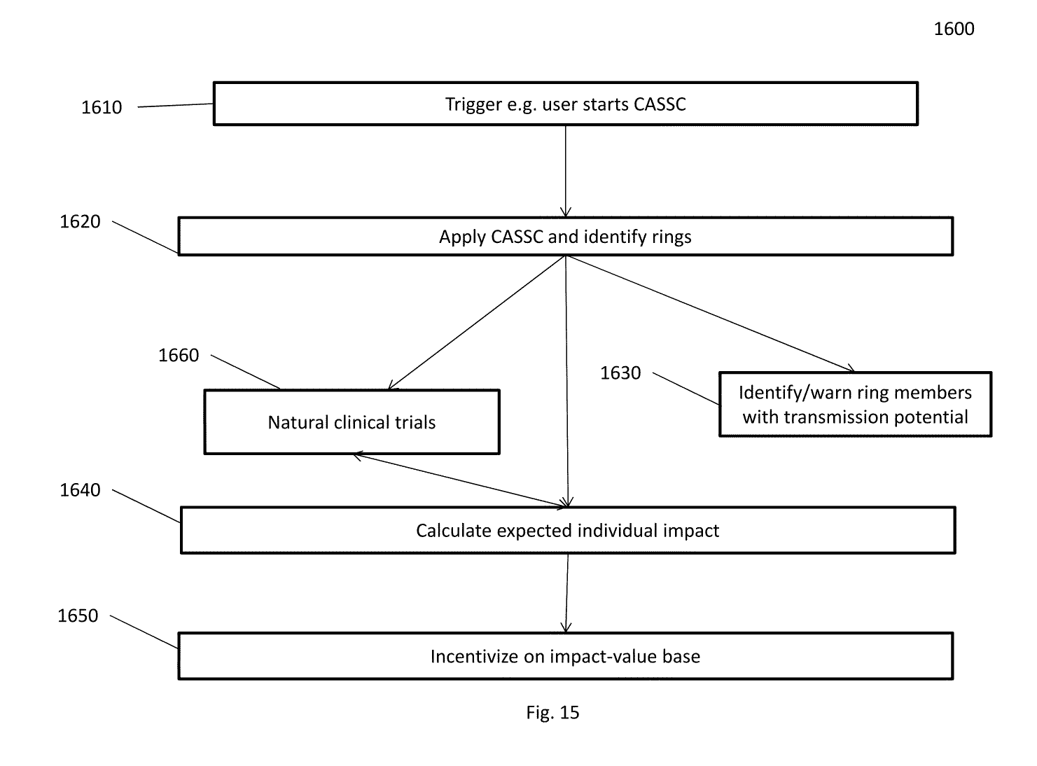

Attention is now drawn to FIG. 15, showing utilization of social network data by the system, in accordance with certain examples of the presently disclosed subject matter.

“Social networks” (SN) such as Facebook, LinkedIn, Twitter, and others, are used by people and contain a wealth of information, part of which can be relevant to the processes described herein. In some cases, the system can utilize Social Network (SN) data, such as “friendship information” (indications of social relationships between two or more individuals) contained/existing in these networks, for example as qualities in ring definitions. For example, the distance measure between individuals may be calculated by using a subset of data contained in the SN, alone or in combination with other available data.

The SN data can be used by the system for example when it is desired to apply the various processes described herein on large areas/communities, where a community may be e.g. a group of people that go to the same school, gym, work place, etc., or an “online community”, e.g. all users of a certain social network (such as Facebook), or any subset, etc.

Mass-diagnosis/treatment etc. (1600), is the process of utilizing CASSC (or rings by themselves) across a wide platform to identify groups of people that may be associated with a particular ring. This function may be triggered manually or automatically, for example in response to any ring behavior as may be defined e.g. by the system, by an MD or health organization, etc. For example, the system identifies an emerging ring associated with fast transmission and severe illness and based on defined parameters initiates “mass-diagnosis” (block 1610). In another example the trigger may be set by a facility and aim at specific user or a group of users, e.g. to keep track of discharged patients or gain epidemiological insights into e.g. potential facility-related infections.

SN data may be relevant in context when e.g. it is used as part of the ring-definition.

In response to the trigger (block 1610), e.g. an emerging ring, the system will identify all suspected current/past etc. ring members as well as potential future members, i.e. individuals that are predicted by the system (at any set level of confidence) to become members of said ring based on e.g. physical distance from current/past ring members, patient group, etc. Some or all of these users may then be approached (1620) by the system (e.g. by prompting CASSC on any user device/system). The specific CASSC question set may vary among users and/or between groups of approached users, e.g. one CASSC question set for current members of the ring and another for members predicted to enter the ring.

It may also vary within these groups, e.g. in the symptom selection process the purpose of the procedure can be to identify recovery for some current members and response to other factors for others. Moreover, the specific symptoms presented may depend on the user profile in the system, e.g. standard qualities such as those used in defining rings, and it should be emphasized, also individual ‘qualities’, such as the expected amount of patience specific user has in filling forms, tendency to choose his own symptoms and not from list, consistency in responses, etc.

Regardless, the sampling process itself (1575) ensures some variability in the CASSC sequence.

The CASSC applied to current/past ring members may be used e.g. to improve the ring definition or explore factors potentially linked to transmission or prognosis, e.g. the response of ring members to various treatments may be explored and quantified (linked also to block 1660). In terms of potential/predicted users the aim of the CASSC provided may be to rapidly identify/verify new ring members. In addition, the system may provide warnings to some or all users and related preventive (or treatment, etc.) information (block 1630).

Mass-diagnosis can be used in any kind of health related effort, such as containing the spread of infections (block 1630), identifying emerging hazards, quantify the impact of specific pathogens (or rings not containing exact pathogens), quantify the individual impact of users in terms of the spread of infections, etc.

Mass diagnosis can be used to calculate the ‘expected individual impact’ (block 1640), which may simply be defined e.g. as the probability of becoming (any or a set) ring-member multiplied by the average expected number of infected, multiplied by the per person cost (mean or individual if data exists); the per person cost may be based on known data (e.g. an existing estimate of the per person cost of “symptomatic flu”) or calculated based on other parameters such as the cost of hospitalization (which may be area/facility specific) per day, loss of work days, the cost of treatment, etc.

This quantitative expected impact provides a powerful tool for larger entities, e.g. governments and HMOs to approach and reward users for taking preventive actions. Furthermore, ‘real outcome’ of actions may be assessed from updated ring data. This may be used e.g. to incentivize users to act in a health promoting manner (1650) e.g. may receive a health insurance deduction if user took effective/suggested measures to prevent ring spread. This approach/reward system is dynamic and may be calculated once every period or on other basis, such as ‘per action’, i.e. every time user is approached a deduction becomes possible if actions are taken.

Mass diagnosis may also be used to conduct “natural clinical trials”, in which the effect of a factor, e.g. aspirin or air pollution levels etc. may be quantified using members of one or a set of rings for which data regarding the factor is known, i.e. the factor (e.g. aspirin) is a quality associated with those rings. These may be done in retrospect using stored data. Prospective trials may use a similar approach but may be further improved by using the “sampling” function of CASSC (1575) to specifically “research” the role of some factor, regardless of its relevance to the actual ring definitions that are investigated.

In some cases, in accordance with the presently disclosed subject matter, various images of various types can be used by the system. Real-time data can exist in image form, e.g. a forest structure and components (grass, land, dirt, dry matter etc.), satellite images, street cameras, etc. Many of these images data may be used as qualities by the system, e.g. in using satellite images of an area in defining groups of LTZs. in accordance with the presently disclosed subject matter, a new way to use such data in presented context (or other as may apply) by conceptually treating the image as the data it represents is described.

An image can be translated into an array or a set of arrays (as in RGB, TIFF images); the image may be recalled in size, color, etc. or superimposed on other images. Each entry in an array, (also referred to as pixel), is an independent unit or part of a larger unit (e.g. a LTZ). Each pixel may be defined as a quality. For example, population density may be associated with a set of defined pixels, e.g. red represents high density, blue represents low density, etc.

The process of defining the association between the image and the data it represents may be done manually by a user or automatically based on existing manual definitions or image analysis algorithms. The resulting association definitions may apply to one or more parts of an image.

Note these definitions may be shared (and may be modified further) or used in other contexts, even in CASSC, where the symptom may be an image, manipulated (for example as detailed herein) or not. Note that any image analysis and/or manipulation technique may be applied to one or more images. Note also the image itself may be a manipulated image, edited for example using any photo editing tool such as Photoshop, etc.). Such image may be used as “data”.

In some cases, the purpose of using of an image may vary and may depend on context. One example is using an image containing population density data (where density was defined by the user/system) for the purpose of calculating/predicting the progress of a ring, e.g., determining the next LTZ likely to be affected. This may be done for example as follows:

The location of some ring members (e.g. flu patients in an area divided into LTZs) at time t (e.g. derived from clinical test data) is set on the map itself, e.g. pixel 37 has 0 pathogens, pixel 38 has 3 cases of Virus 1 (clean signal) and pixel 40 has 1 case of virus 1 and 4 cases of virus 2 (signal overlap), etc.

The system can be configured to calculate the number of cases in said pixels (using known methodology), i.e. the pixel's internal dynamics, and then the transmission to other pixels is predicted based on virus density at nearby pixels (e.g. pixel 41 has potential for Virus 2 spread, pixel 35 has potential for Virus 1 invasion) and/or other qualities, such as individuals reporting symptoms via a designated application, etc. or through other data sources (as can be obtained for example via tweeter mining, google flu trends data, etc.). This example may be generalized to other frames, e.g. cancer spread in a tissue may be simulated based on the actual structure of the tumor.

This approach may be applied to any data problem that can be understood visually, such as the spread of forest fires, growth of cancer cells in tissue (or skin), etc.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A system for diagnosing a patient, the system comprising at least one processor configured to perform the following:
obtain at least (a) data defining at least two distinct Local Transmission Zones (LTZs), each LTZ of the LTZs associated with a given diagnosis out of a plurality of potential diagnoses, and (b) patient-related information enabling associating the patient with a given LTZ of the LTZs; and
associate the patient with the given LTZ thereby enabling determination of the patient's diagnosis in accordance with the given diagnosis associated with the given LTZ.

2. The system of claim 1 wherein the patient-related information is obtained via a user device and wherein the processor is further configured to provide the patient's diagnosis to the user via the patient device.

3. The system of claim 1 wherein the data defining at least two distinct LTZs is obtained from a data repository, directly or indirectly.

4. The system of claim 1 wherein the LTZs are non-overlapping.

5. The system of claim 1 wherein (1) each LTZ is a sub-area of a given geographical area, (2) the patient-related information includes information of at least one geographical location associated with the patient and (3) the association is performed by determination of the LTZ encompassing the geographical location of the patient.

6. The system of claim 1 wherein (1) each LTZ is a group of people out of a certain population (2) the patient-related information includes information of at least one relationship of the patient with another person of the population, and (3) the association is performed by determination of the LTZ encompassing the other person.

7. The system of claim 6 wherein the relationship is a spatial relationship being indicative of a distance between the patient and the other person.

8. The system of claim 1 wherein the processor is further configured to perform the following for obtaining the data defining at least two distinct Local Transmission Zones (LTZs):
obtain LTZ generation data including at least clinical tests results data and spatial information relating to corresponding patients associated with the clinical test results; and
generate the LTZs based on the obtained LTZ generation data.

9. The system of claim 9 wherein the processor is further configured to perform the following for generating the LTZs:
(e) cluster a given geographical area into two or more candidate LTZs each covering a sub-portion of the given geographical area;
(f) grade the candidate LTZs;
(g) cluster the sub-portions covered by the candidate LTZs for which the grade is below a threshold; and
(h) repeat steps (b) and (c) until all the grades of the candidate LTZs are above the threshold.

10. The system of claim 9 wherein the grade is calculated per given causing agent.

11. The system of claim 9 wherein the grade is based on at least one of: Signal Separation (SS), Signal Continuity (SC), Spatial Distribution Test (SDT), disease ratio.

12. The system of claim 11 wherein the SS is calculated using a signal that is a function of a number of incidences of a causing agent, the sub-portion of the given geographical area covered by the LTZ and a given timeframe.

13. A method for diagnosing a patient, the method comprising:
obtaining, by a processor, at least (a) data defining at least two distinct Local Transmission Zones (LTZs), each LTZ of the LTZs associated with a given diagnosis out of a plurality of potential diagnoses, and (b) patient-related information enabling associating the patient with a given LTZ of the LTZs; and
associating the patient with the given LTZ thereby enabling determination of the patient's diagnosis in accordance with the given diagnosis associated with the given LTZ.

14. The method of claim 13 wherein the patient-related information is obtained via a user device and wherein the method further comprises providing the patient's diagnosis to the user via the patient device.

15. The method of claim 13 wherein the data defining at least two distinct LTZs is obtained from a data repository, directly or indirectly.

16. The method of claim 13 wherein the LTZs are non-overlapping.

17. The method of claim 13 wherein (1) each LTZ is a sub-area of a given geographical area, (2) the patient-related information includes information of at least one geographical location associated with the patient and (3) the associating is performed by determining the LTZ encompassing the geographical location of the patient.

18. The method of claim 1 wherein (1) each LTZ is a group of people out of a certain population (2) the patient-related information includes information of at least one relationship of the patient with another person of the population, and (3) the associating is performed by determining the LTZ encompassing the other person.

19. The system of claim 18 wherein the relationship is a spatial relationship being indicative of a distance between the patient and the other person.

20. The method of claim 13 wherein the obtaining includes:
obtaining LTZ generation data including at least clinical tests results data and spatial information relating to corresponding patients associated with the clinical test results; and
generating the LTZs based on the obtained LTZ generation data.

21. The method of claim 20 wherein the generating includes:
(i) clustering a given geographical area into two or more candidate LTZs each covering a sub-portion of the given geographical area;
(j) grading the candidate LTZs;
(k) clustering the sub-portions covered by the candidate LTZs for which the grade is below a threshold; and
(l) repeating steps (b) and (c) until all the grades of the candidate LTZs are above the threshold.

22. The method of claim 21 wherein the grading is calculated per given causing agent.

23. The method of claim 21 wherein the grading is based on at least one of: Signal Separation (SS), Signal Continuity (SC), Spatial Distribution Test (SDT), disease ratio.

24. The method of claim 23 wherein the SS is calculated using a signal that is a function of a number of incidences of a causing agent, the sub-portion of the given geographical area covered by the LTZ and a given timeframe.

25. A non-transitory computer readable storage medium having computer readable program code embodied therewith, the computer readable program code, executable by at least one processor of a computer to perform a method comprising:
obtaining, by a processor, at least (a) data defining at least two distinct Local Transmission Zones (LTZs), each LTZ of the LTZs associated with a given diagnosis out of a plurality of potential diagnoses, and (b) patient-related information enabling associating the patient with a given LTZ of the LTZs; and
associating the patient with the given LTZ thereby enabling determination of the patient's diagnosis in accordance with the given diagnosis associated with the given LTZ.
